(19) United States
(12) Patent Application Publication
(10) Pub. No.: US 2023/0273945 A1
(43) Pub. Date: Aug. 31, 2023

(54) SYSTEMS AND METHODS FOR DEPOSITION PROCEEDINGS

(71) Applicant: CLOUD COURT, INC., Minneapolis, MN (US)

(72) Inventors: Michael David OKERLUND, Minneapolis, MN (US); Norman Ira TAPLE, Minneapolis, MN (US); Milena HIGGINS, Vadnais Heights, MN (US)

(21) Appl. No.: 18/024,129

(22) PCT Filed: Sep. 1, 2021
(86) PCT No.: PCT/US2021/048702

§ 371 Date: Mar. 1, 2023

Related U.S. Application Data
(60) Provisional application No. 63/073,407, filed on Sep. 1, 2020.
(60) Provisional application No. 63/109,824, filed on Nov. 4, 2020.
(60) Provisional application No. 63/149,052, filed on Feb. 12, 2021.
(60) Provisional application No. 63/170,301, filed on Apr. 2, 2021.
(60) Provisional application No. 63/222,812, filed on Jul. 16, 2021.

(51) Int. Cl. G06F 16/33; G06F 16/332; G10L 15/26; G06Q 50/18

(52) U.S. Cl. CPC G06F 16/3334; G06F 16/332; G10L 15/26; G06Q 50/18

(57) ABSTRACT

A method for taking depositions includes receiving an output signal from one or more microphones, the output signal representing content from a proceeding having two or more participants and generating a real-time transcript based on the received output signal. The real-time transcript is displayed via a user interface. Search terms are selected based on the real-time transcript and a search of a database is conducted based on the selected search terms. The results are then displayed via the user interface.

### CROSS-REFERENCE TO RELATED APPLICATIONS

This application claims benefit of U.S. Provisional Application No. 63/073,407, filed on Sep. 1, 2020, U.S. Provisional Application No. 63/109,824, filed on Nov. 4, 2020, U.S. Provisional Application No. 63/149,052, filed on Feb. 12, 2021, U.S. Provisional Application No. 63/170,301, filed on Apr. 2, 2021, and U.S. Provisional Application No. 63/222,812, filed on Jul. 16, 2021, each of which is incorporated by reference herein. A claim of priority is made.

### BACKGROUND

This disclosure is directed to deposition proceedings. Typically, a deposition proceeding is attended by a court reporter or stenographer that records the deposition. At some point subsequent to the deposition proceeding, the court reporter or stenographer provides a transcript that is made available to the respective parties. In addition to the delay in time between the deposition and the delivery of the transcript, the cost of the stenographer may be potentially high. Additionally, in the context of cases involving large amounts of discovery, it is often difficult or impossible to quickly and easily identify additional documents with which to question a witness. It would therefore be beneficial to develop a system that addresses these issues.

### SUMMARY

According to one aspect, a method includes receiving an output signal from one or more microphones, the output signal representing content from a proceeding having two or more participants and generating a real-time transcript based on the received output signal. The method may further include displaying the real-time transcript via a user interface and selecting search terms from the real-time transcript. The method may further include conducting a search of a database storing electronic documents related to the proceeding based on the selected search terms and displaying the search results via the user interface.

According to another aspect, a system includes at least one microphone and a user interface device accessible to at least one of a plurality of deposition participants. The system further includes an audio translation engine that includes an audio storage module configured to store at least one representation of audio recorded by the at least one microphone during a deposition proceeding, a speech-to-text module configured to convert speech of the recorded audio into a textual representation of the speech, and a transcript generator module configured to generate a document representing a transcript of the deposition based on the converted speech and the identified which of the plurality of deposition participants spoke the one or more portions. In addition, a search engine configured to interface with a database storing electronic documents relevant to the deposition proceeding, the search engine configured to generate search parameters based on the generated transcript and to display results via the user interface.

According to another aspect, a computer readable storage medium having data stored therein representing software executable by a computer, the software including instructions that when executed by the computer perform steps that include receiving an electronic version of a real-time transcript generated in response to an on-going proceeding. The steps may further include displaying the real-time transcript via a display and selecting content from the real-time transcript based on input received from one or more users granted access to the real-time transcript. The steps may further include formatting a search query based on the selected content and communicating the search query to a database. The steps may further include receiving information identifying one or more documents retrieved in response to the search query and displaying information identifying the one or more documents retrieved in response to the search query.

### DESCRIPTION OF THE DRAWINGS

FIG. 1 is a conceptual diagram depicting an automated legal proceeding assistant consistent with one or more aspects of this disclosure.

FIG. 2 is a block diagram depicting components of an automated legal proceeding assistant system consistent with one or more aspects of this disclosure.

FIGS. 3A-3C are conceptual diagrams depicting the recording of speech from deposition participants to generate a transcript consistent with one or more aspects of this disclosure.

FIG. 4A and 4B are conceptual diagrams depicting examples of recording of speech from deposition participants to generate a transcript consistent with one or more aspects of this disclosure.

FIG. 5 is a conceptual diagram depicting one example of audio processing to generate a transcript consistent with one or more aspects of this disclosure.

FIG. 6 is a conceptual diagram depicting one example of data that may be stored by a server consistent with one or more aspects of this disclosure.

FIG. 7 is a flow diagram depicting one example of a method of automatically generating a legal proceeding transcript consistent with one or more aspects of this disclosure.

FIG. 8 is a block diagram illustrating a computing environment in which respective components of an automated legal proceeding assistant system may operate consistent with one or more aspects of this disclosure.

FIG. 9 is a screenshot of a user interface provided by the automated legal proceeding assistant consistent with one or more aspects of this disclosure.

FIG. 10 is a screenshot of a user interface provided by the automated legal proceeding assistant consistent with one or more aspects of this disclosure.

FIG. 11 is a screenshot of a user interface provided by the automated legal proceeding assistant consistent with one or more aspects of this disclosure.

FIG. 12 is a conceptual diagram of a user interface running a subset of modules associated with the automated legal proceeding assistant consistent with one or more aspects of this disclosure.

FIG. 13 is an exemplary document created using a notice and stipulation module associated with the automated legal proceeding assistant consistent with one or more aspects of this disclosure.

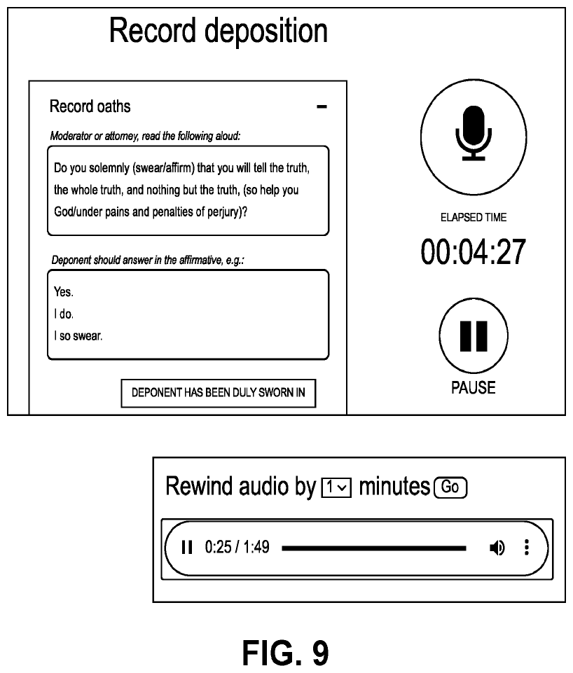

FIG. 9 is a screenshot of a display interface displayed to a user of the automated legal proceeding assistant consistent with one or more aspects of this disclosure.

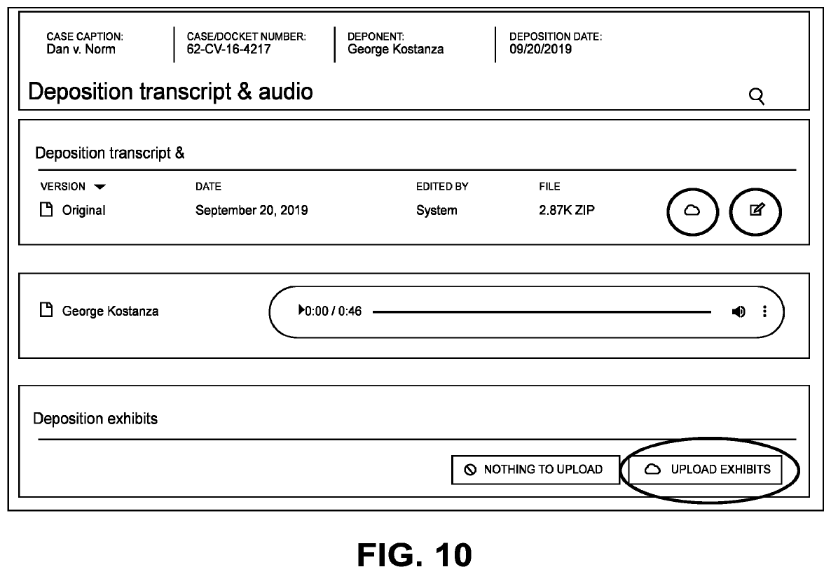

FIG. 10 is a screenshot of a display interface displayed to a user of the automated legal proceeding assistant consistent with one or more aspects of this disclosure.

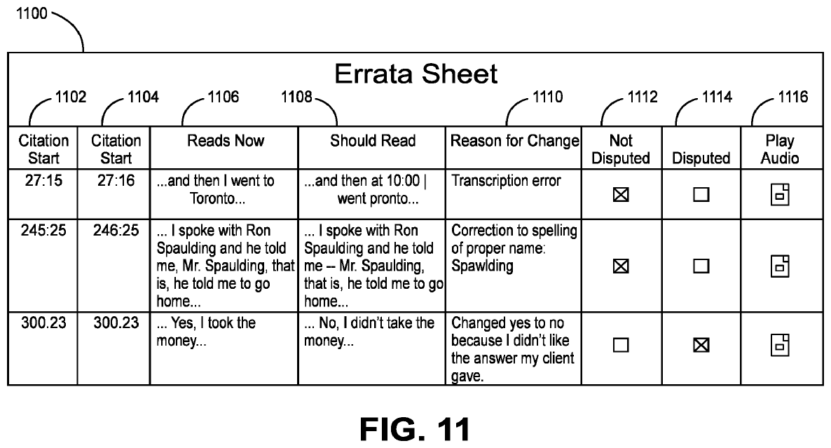

FIG. 11 is a screenshot of an errata sheet generated by the automated legal proceeding assistant consistent with one or more aspects of this disclosure.

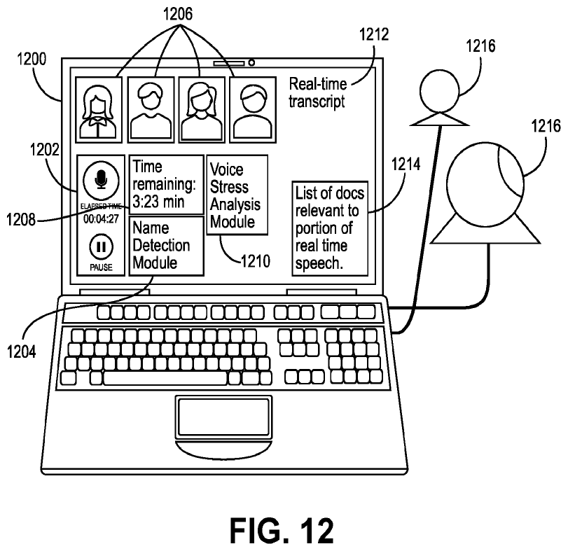

FIG. 12 is a diagram of a user interface presented to a user consistent with one or more aspects of this disclosure.

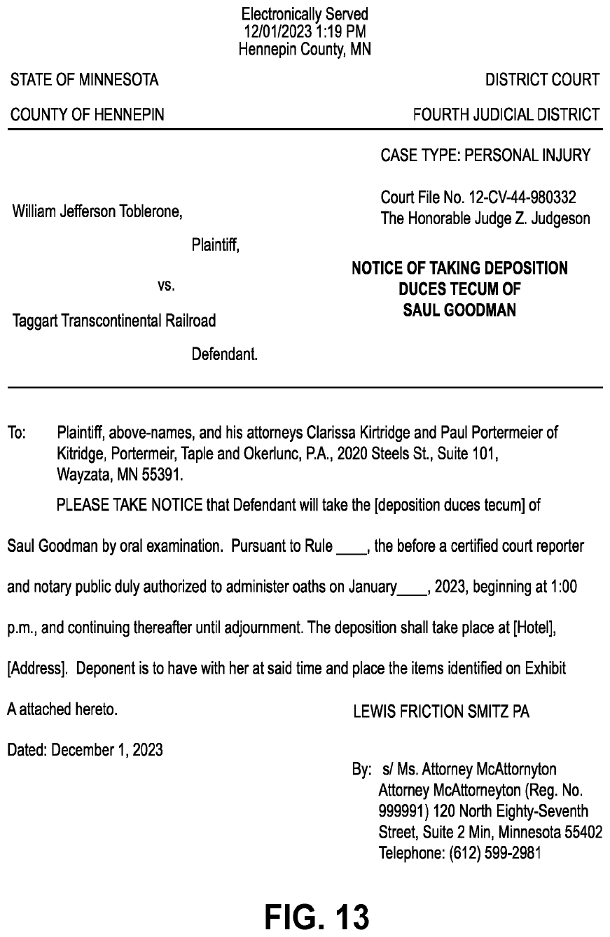

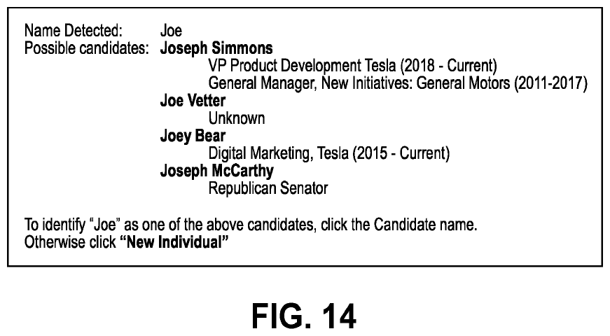

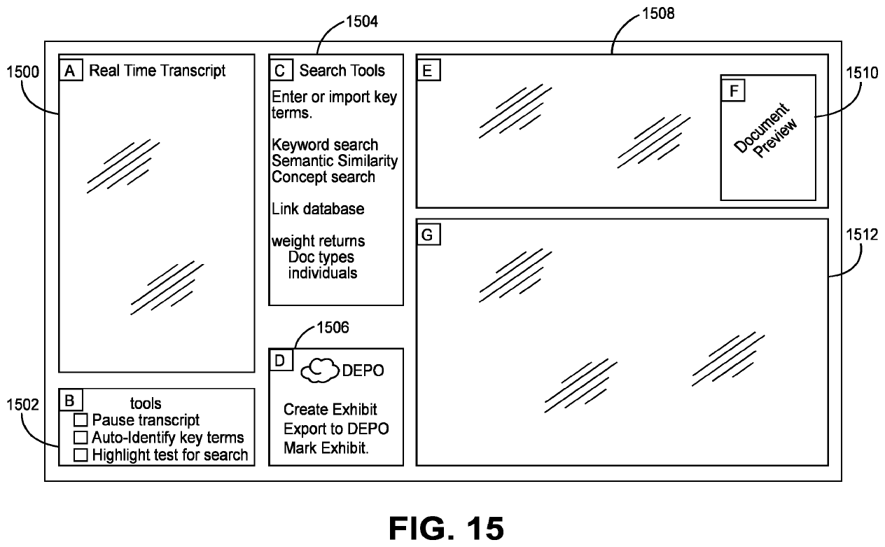

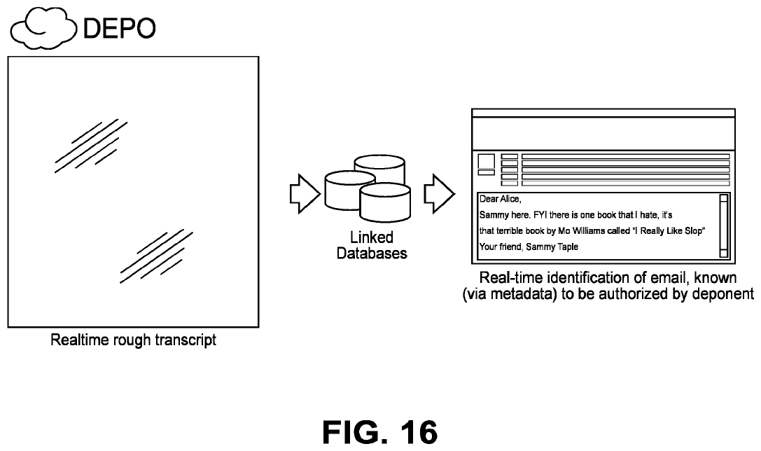

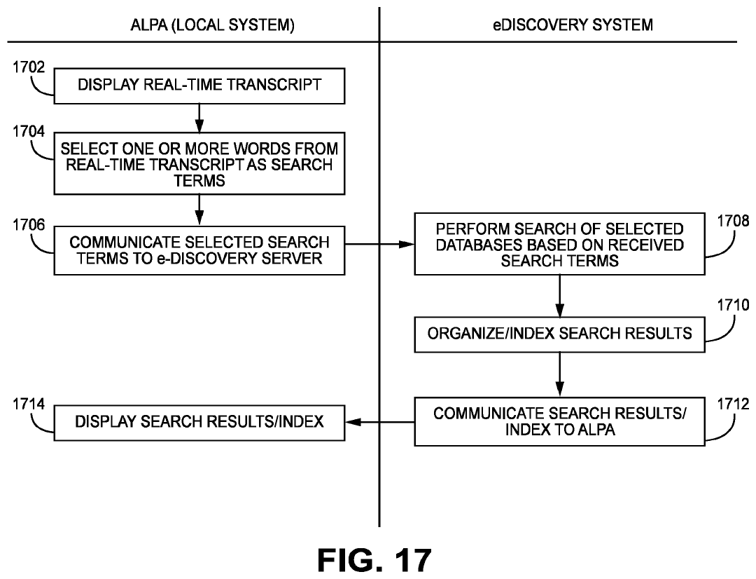

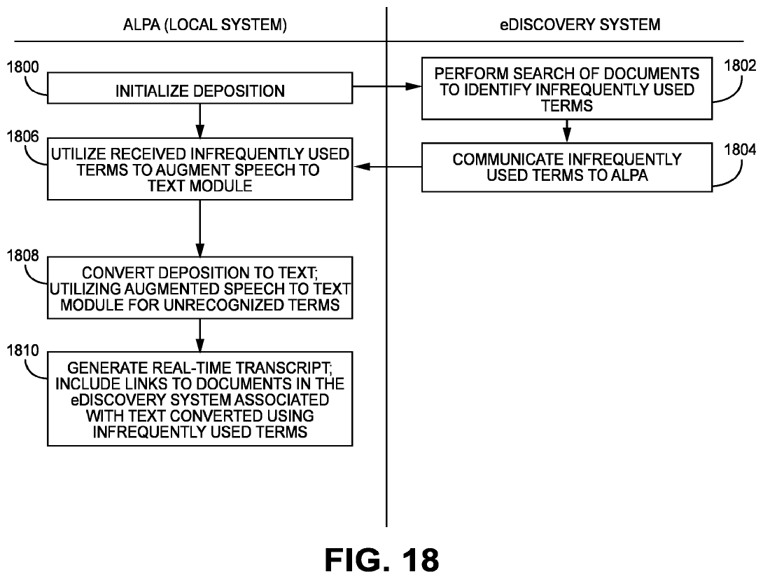

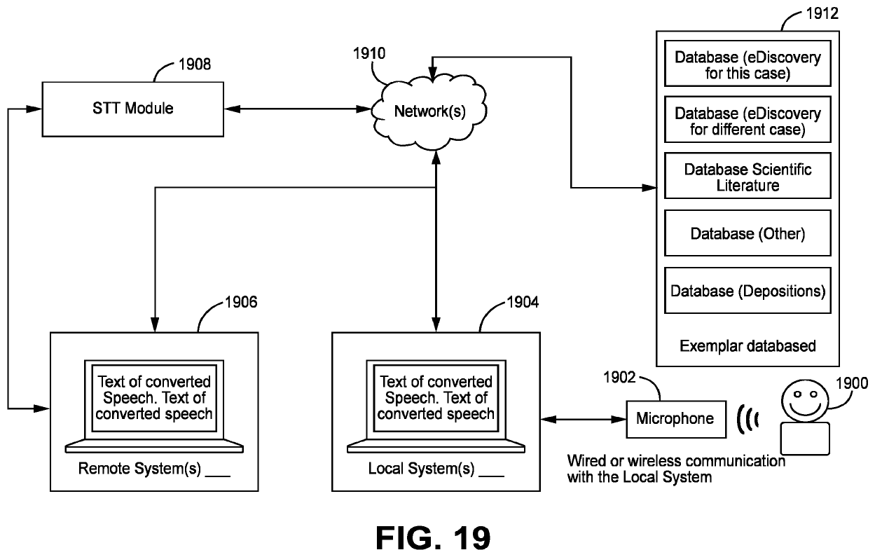

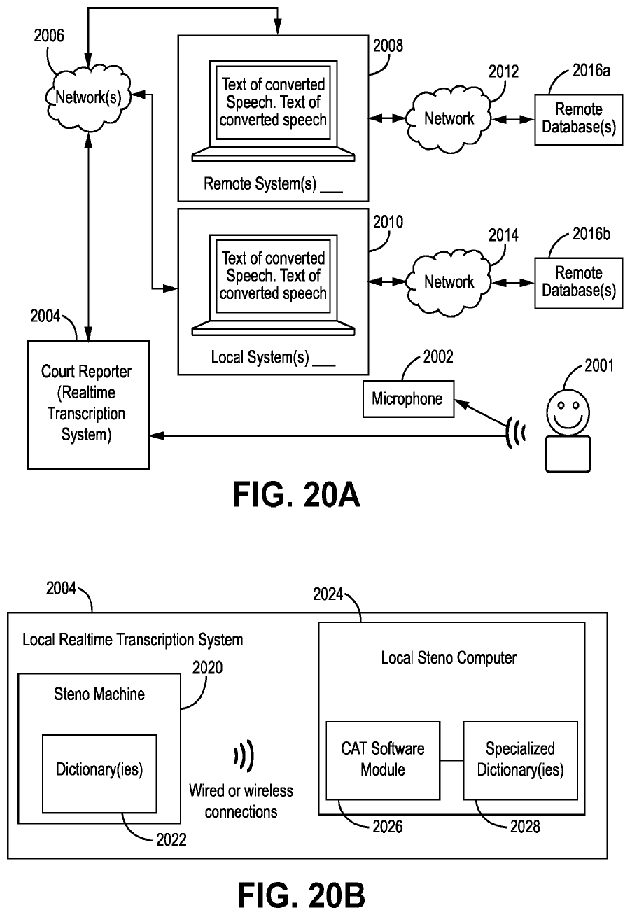

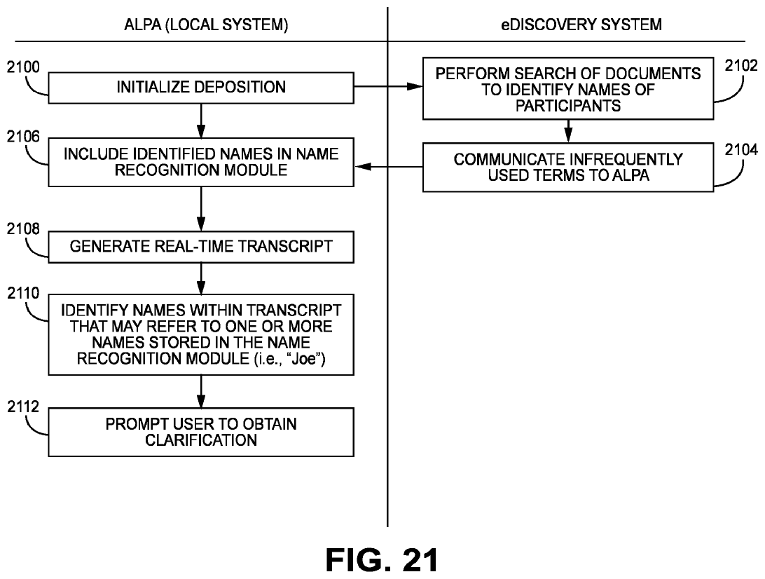

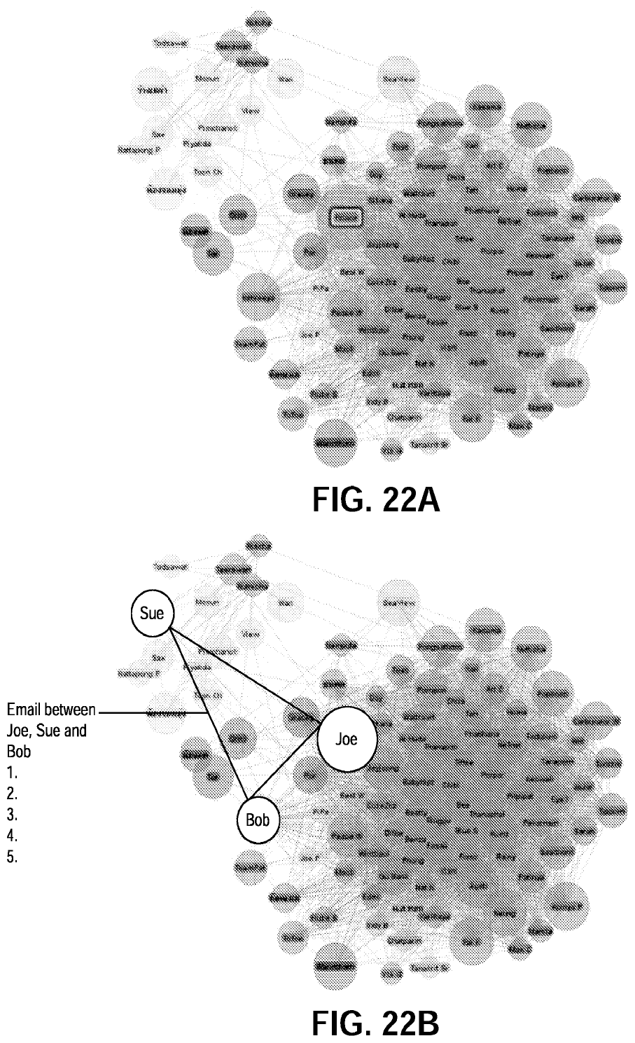

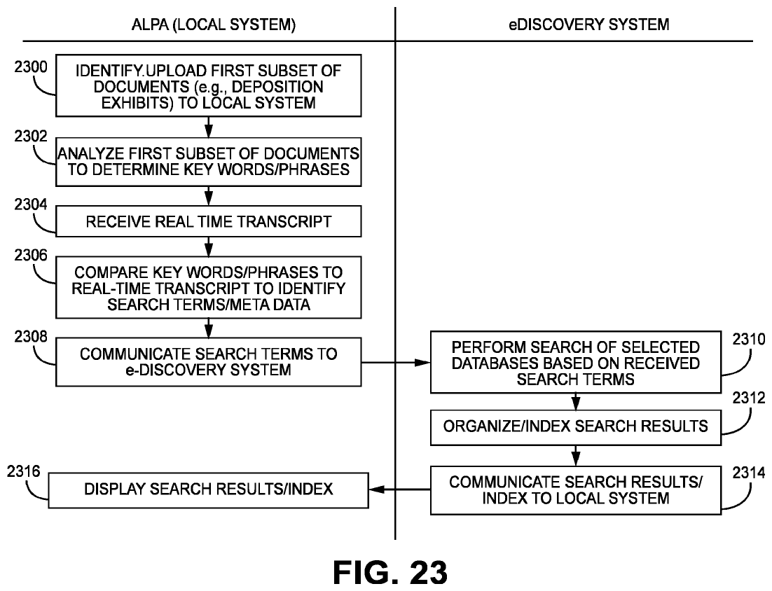

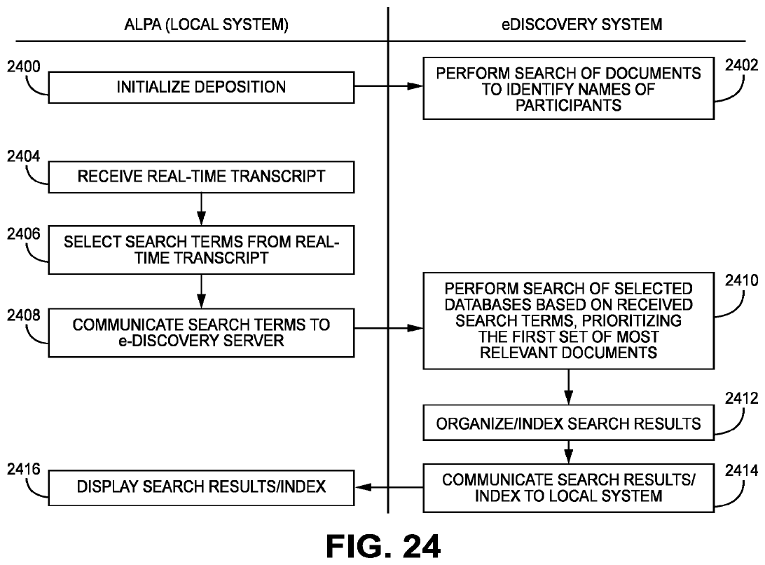

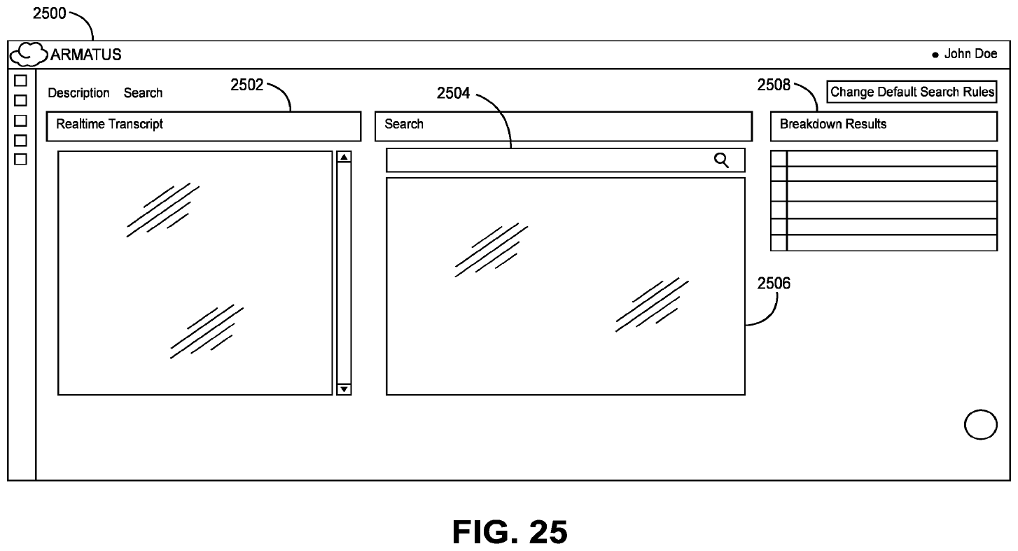

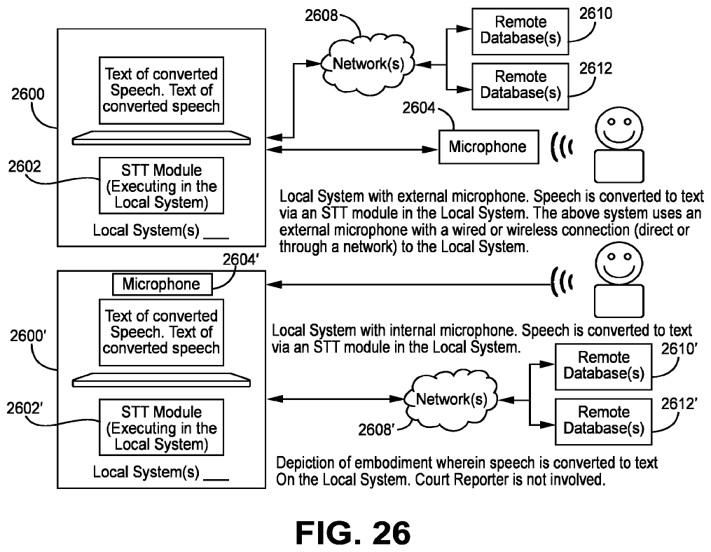

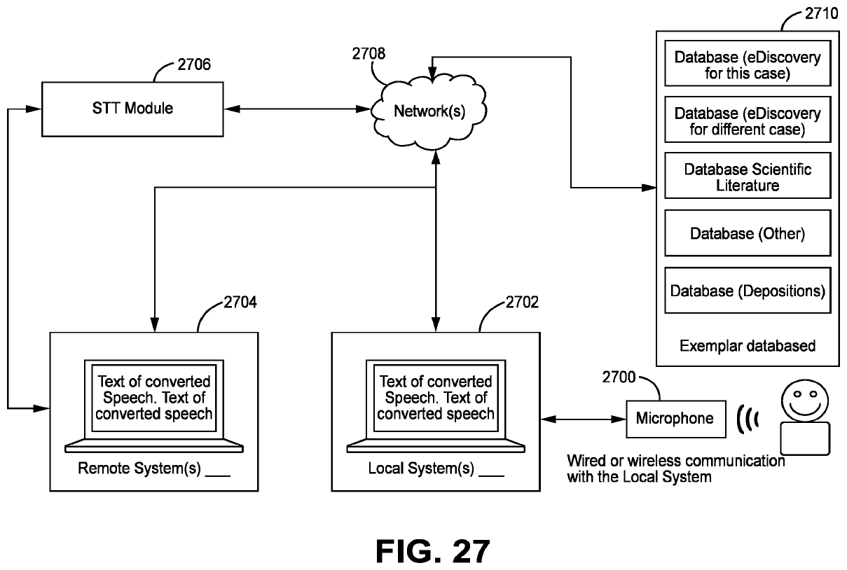

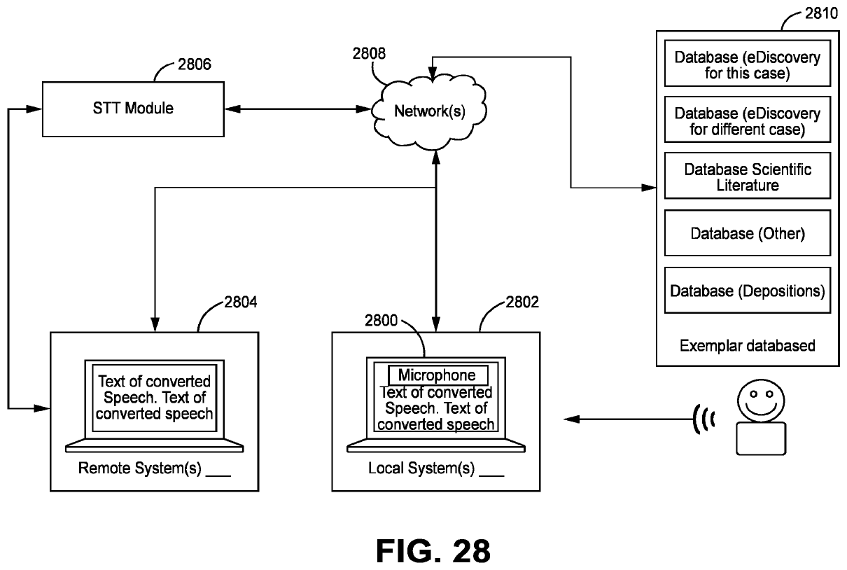

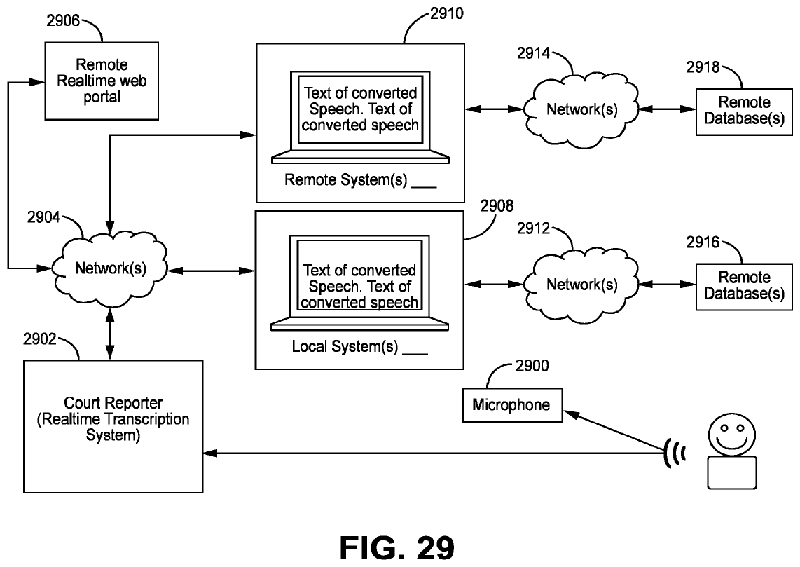

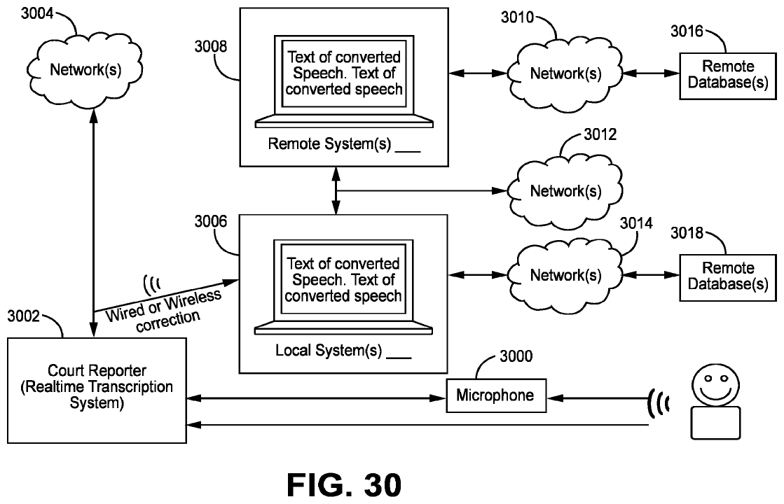

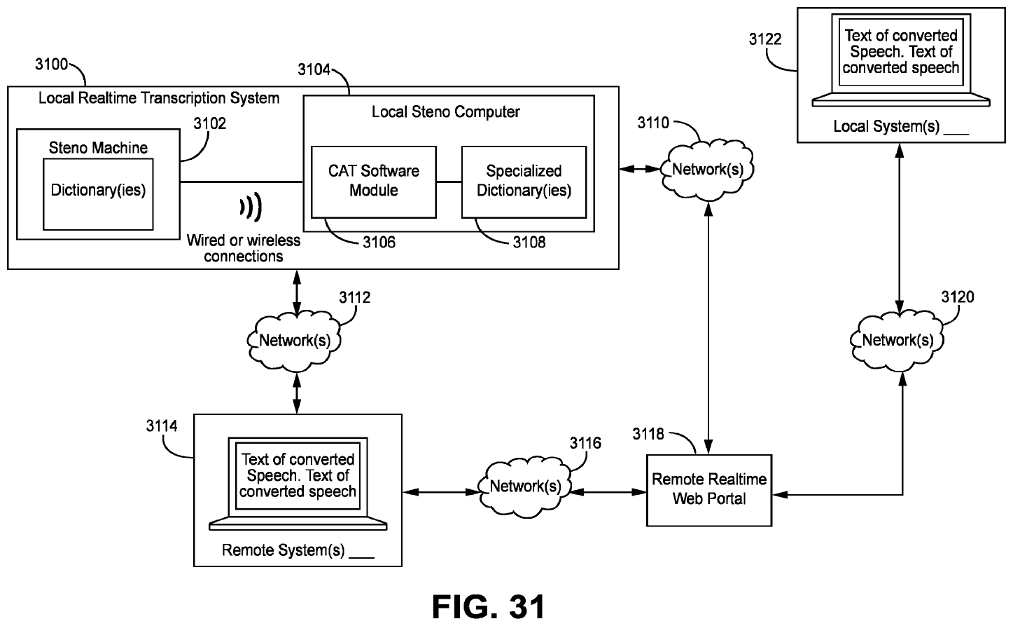

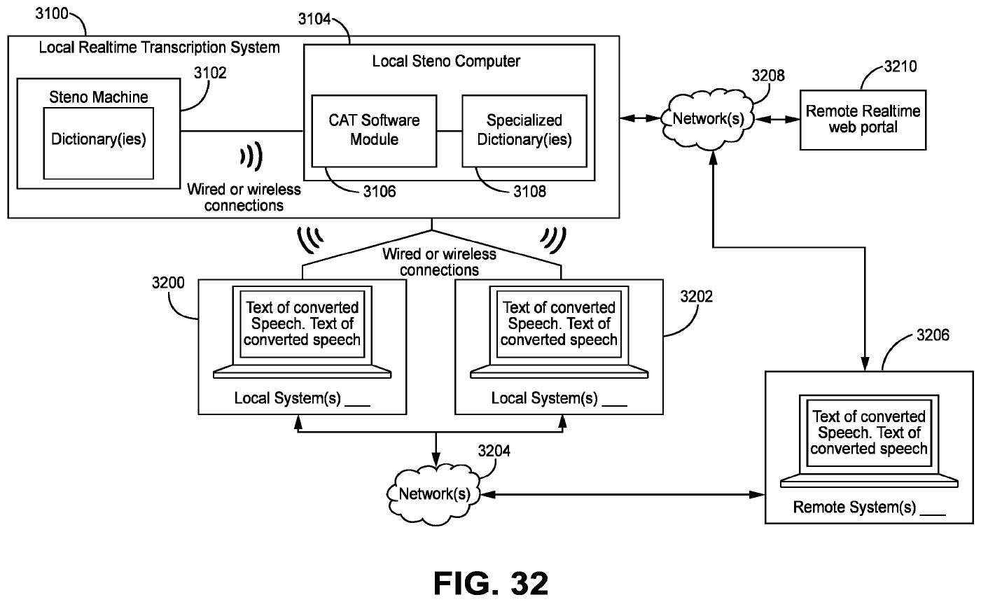

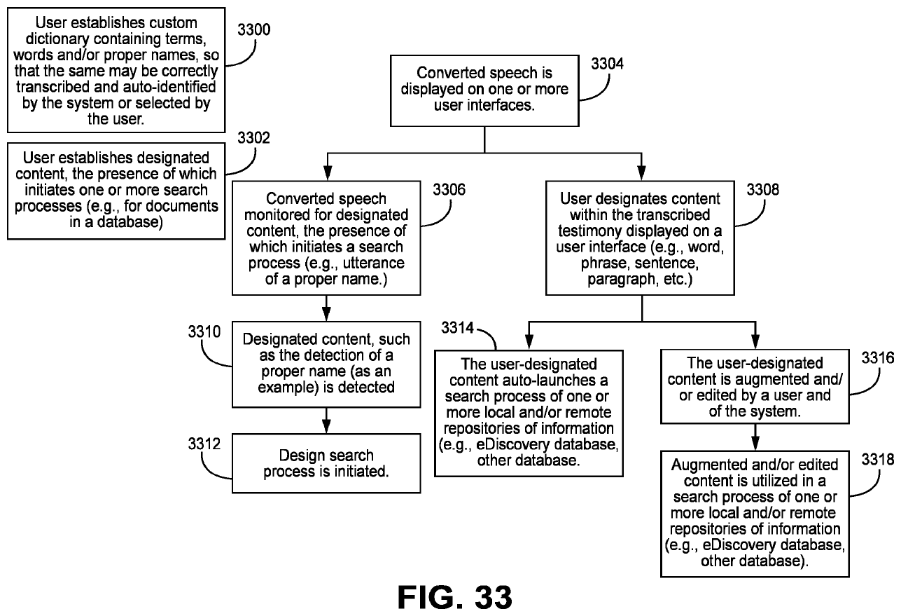

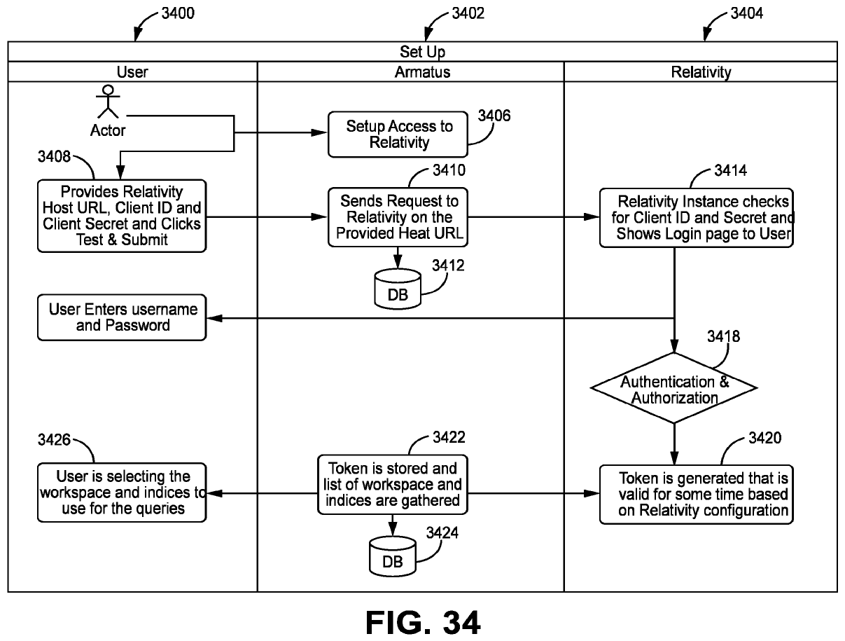

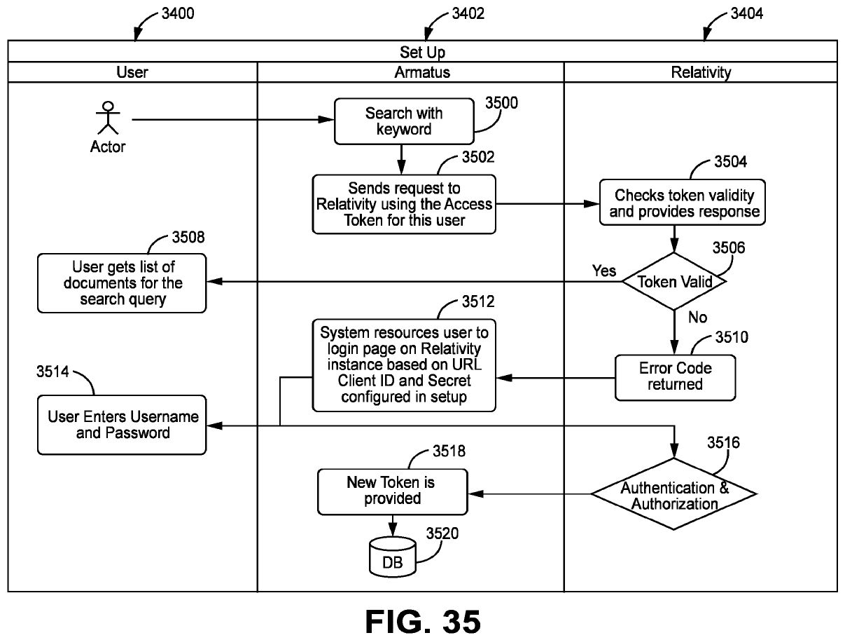

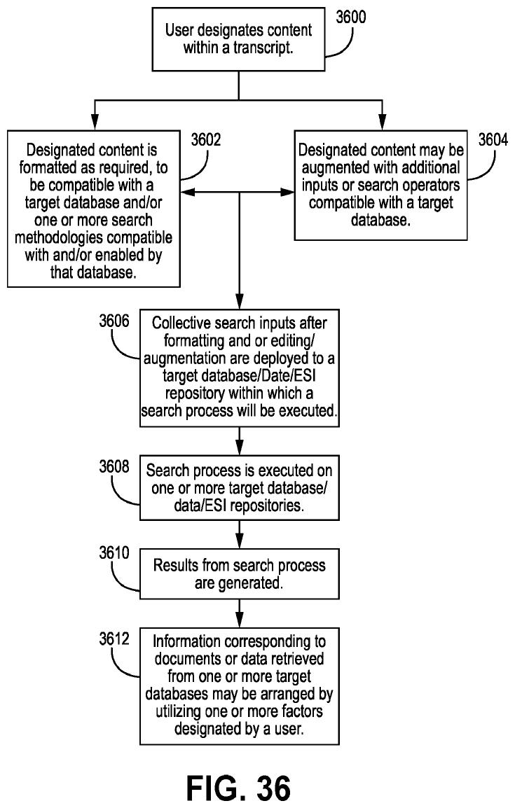

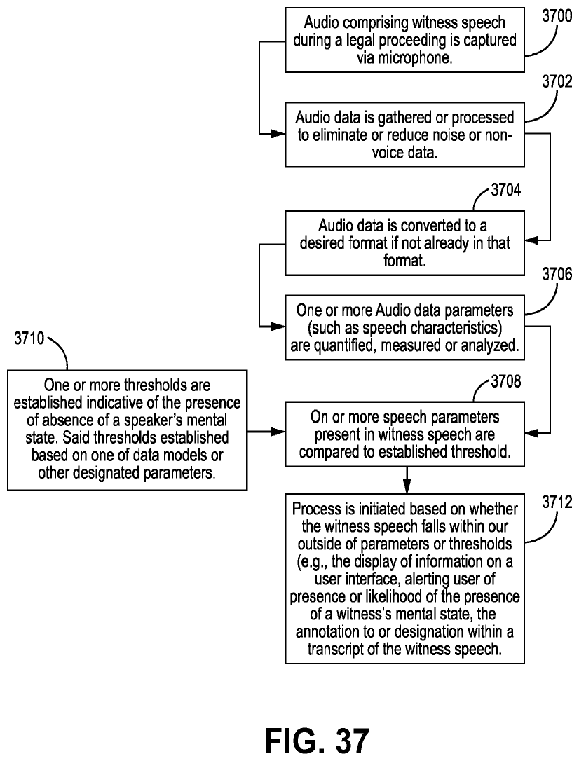

FIG. 13 is a sample notice generated by the automated legal proceeding assistant consistent with one or more aspects of this disclosure.

FIG. 14 is a screenshot of a user interface presented to a user by the automated legal proceeding assistant consistent with one or more aspects of this disclosure.

FIG. 15 is a screenshot of a user interface presented to a user by the automated legal proceeding assistant consistent with one or more aspects of this disclosure.

FIG. 16 is a block diagram of the selection of text from the real-time transcript being utilized to conduct a search of connected eDiscovery databases consistent with one or more aspects of this disclosure.

FIG. 17 is a flowchart of a steps performed by the automated legal proceeding assistant in conjunction with an eDiscovery system consistent with one or more aspects of this disclosure.

FIG. 18 is a flowchart of a steps performed by the automated legal proceeding assistant in conjunction with an eDiscovery system consistent with one or more aspects of this disclosure.

FIG. 19 is a block diagram of an automated legal proceeding assistant and eDiscovery system consistent with one or more aspects of this disclosure.

FIG. 20A is a block diagram of an automated legal proceeding assistant and eDiscovery system consistent with one or more aspects of this disclosure.

FIG. 20B is a block diagram of a local real-time transcription system consistent with one or more aspects of this disclosure.

FIG. 21 is a flowchart of a steps performed by the automated legal proceeding assistant in conjunction with an eDiscovery system consistent with one or more aspects of this disclosure.

FIG. 22A and 22B are relationship diagrams illustrating relationships between various people based on analysis of the eDiscovery system.

FIG. 23 is a flowchart of a steps performed by the automated legal proceeding assistant in conjunction with an eDiscovery system consistent with one or more aspects of this disclosure.

FIG. 24 is a flowchart of a steps performed by the automated legal proceeding assistant in conjunction with an eDiscovery system consistent with one or more aspects of this disclosure.

FIG. 25 is a screenshot of a user interface displayed to a user consistent with one or more aspects of this disclosure.

FIG. 26 is block diagram illustrating a real-time transcription system consistent with one or more aspects of this disclosure.

FIG. 27 is block diagram illustrating a real-time transcription system consistent with one or more aspects of this disclosure.

FIG. 28 is block diagram illustrating a real-time transcription system consistent with one or more aspects of this disclosure.

FIG. 29 is block diagram illustrating a real-time transcription system consistent with one or more aspects of this disclosure.

FIG. 30 is block diagram illustrating a real-time transcription system consistent with one or more aspects of this disclosure.

FIG. 31 is block diagram illustrating a real-time transcription system consistent with one or more aspects of this disclosure.

FIG. 32 is block diagram illustrating a real-time transcription system consistent with one or more aspects of this disclosure.

FIG. 33 is a flowchart illustrating steps performed by the automated legal proceeding assistant in conjunction with an eDiscovery system consistent with one or more aspects of this disclosure.

FIG. 34 is a flowchart illustrating communication between a user, an automated legal proceeding assistant, and eDiscovery system to initialize the eDiscovery system for search consistent with one or more aspects of this disclosure.

FIG. 35 is a flowchart illustrating communication between a user, an automated legal proceeding assistant, and eDiscovery system to initiate a search of the eDiscovery system consistent with one or more aspects of this disclosure.

FIG. 36 is a flowchart illustrating steps performed by the automated legal proceeding assistant in conjunction with an eDiscovery system consistent with one or more aspects of the disclosure.

FIG. 37 is a flowchart illustrating steps performed to analyze audio recordings to detect mental state of one or more participants consistent with one or more aspects of the disclosure.

### DETAILED DESCRIPTION

For clarity, in this disclosure, references to “documents’ shall be construed broadly to encompass any electronically stored information in whatever form.

The term database shall be construed to include any means known or hereinafter developed capable of storing data and documents in an electronic format.

The term deposition shall be construed to include any event during which speech is captured and/or transcribed. For simplicity and clarity, this disclosure will provide examples of systems and methods using the term “deposition” in the classic sense (e.g., a witness, typically sworn in for the purpose of offering testimony in a legal proceeding), however, it should be understood that the systems and methods explained herein are not so limited, and apply to any event during which one or more speakers engage in speech which is captured in any manner for transcription by any means known in the art or hereinafter developed. Such speech events or “depositions” extend, for example, to testimony in a court room, a political speech, any form of oral communication, such as a discussion, colloquy, argument or debate, or any other form of discourse or conversation, whether or not all participants are in the same location.

This disclosure is directed to systems, methods, and techniques for advancements in the noticing, preparation for, taking and transcription of oral testimony, and the identification in real or near-real time of documents which relate to that testimony. In one example, a method is described herein. The method includes recording, using a plurality of microphones, the content of an event where there are one or more speakers, such as a deposition, conversation, discussion, court testimony, a speech, or the like (collectively a “deposition”).

The content of the deposition comprises a plurality of speech segments recorded by the plurality of microphones, wherein each of the plurality of microphones is associated with a deposition participant of a plurality of deposition participants. The method further includes identifying, based on which microphone of the plurality of microphones each speech segment was recorded by, which deposition participant of the plurality of deposition participants is associated with each speech segment. The method incudes, in one embodiment, the use of microphones affixed or attached to a mask or face shield. The method further includes generating, based on which deposition participant of the plurality of deposition participants is identified as associated with each speech segment, a document comprising a transcript of the deposition. The transcript comprises a sequential identification of what content was spoken in each speech segment in written text, and which deposition participant of the plurality of deposition participants spoke the content in each speech segment.

As another example, a system is described herein. The system includes at least one microphone, which in some embodiments may be affixed or attached to a mask or face shield for the prevention of communicable diseases within enclosed spaces. The system further includes a user interface device accessible to at least one of a plurality of deposition participants. The system further includes an audio translation engine. The audio translation engine includes an audio storage module configured to store at least one representation of audio recorded by the at least one microphone during a deposition proceeding. The audio translation engine further includes a speaker identification module configured to identify, in the audio recording, which of the plurality of deposition participants spoke one or more portions of the recorded audio. The audio translation engine further includes a speech-to-text module configured to convert speech of in the recorded audio into a textual representation of the speech. The audio translation engine further includes a transcript generator module configured to generate a document representing a transcript of the deposition based on the converted speech and the identified which of the plurality of deposition participants spoke the one or more portions.

As another example a system is described herein. The system includes at least one microphone configured to capture audio from one or more participants in a single first location. Where one or more additional participants (individuals participating by speaking) are located in an area(s) remote from that first location, the system includes at least one microphone and mechanical speaker (i.e., device) configured to capture audio from, and broadcast audio to, that participant. Where one or more additional observers (individuals equipped to listen to the speech of a participant, but not necessarily participate) are located in an area(s) remote from that first location, the system includes at least one mechanical speaker (device) configured to broadcast audio originating from at least one participant at the first location to that remote observer. The system further includes a user interface device accessible to at least one of a plurality of deposition participants in the first location or locations remote from the first location. The system further includes at least one audio storage module configured to store at least one representation of audio recorded by the at least one microphone during a deposition proceeding, and in preferred embodiments configured to store audio recorded from all participants. The system further includes means to deliver audio to a translation engine and/or a speaker identification module (each of which may be located in a first location or in a remote location), configured to identify, in the audio recording, speech acts of participants and identify which of the plurality of deposition participants spoke one or more portions of the recorded audio. The audio translation engine further includes a speech-to-text module configured to convert speech of in the recorded audio into a textual representation of the speech. The audio translation engine further includes a transcript generator module configured to generate a document representing a transcript of the deposition based on the converted speech and the identity of which of the plurality of deposition participants spoke the one or more portions.

According to another example, a system is described herein. The system includes at least one microphone. The system further includes a user interface device accessible to at least one of a plurality of deposition participants. The system further includes an audio translation engine. The audio translation engine includes or is linked to audio storage means that store at least one representation of audio recorded by the at least one microphone during a deposition proceeding. The audio translation engine further includes a speaker identification means that identify, in the audio recording, which of the plurality of deposition participants spoke one or more portions of the recorded audio. The audio translation engine further includes speech to text means that convert speech of in the recorded audio into a textual representation of the speech. The audio translation engine further includes transcript generation means that generate a document representing a transcript of the deposition based on the converted speech and the identified which of the plurality of deposition participants spoke the one or more portions.

According to another example, a system is described herein. The system includes a testimony analysis module (TAM). The TAM includes at least one user interface, displaying in real or near real time a transcript of speech by one or more participants. The user interface is configured to enable a user to select a word, phrase, name or section within the transcript (or the transcript as a whole) as an input into the construction of search parameters used to identify electronically stored documents or data (documents and data being broadly construed herein to include documents, data, and information in any form), including documents residing in one or more databases. In preferred embodiments, the search parameters utilize one or more search tools, including but not limited to Boolean, Proximity, Stemming, Fielded, Semantic, conceptual, Fuzzy logic type or other searches, and metadata, to preferentially identify documents stored within a local or remote ediscovery database. In another embodiment, the system may incorporate or access via networked means to data stored remotely, including (without limitation) the following examples: third party databases, bibliographic databases, or other proprietary databases (to name a few). Any data stored remotely, in whatever form, may be utilized so long as it is accessible via networked means. Exemplar databases may include IEEE Xplore, Scopus, Web of Science, PubMed (biological and medicine references); ScienceDirect; Directory of Open Access Journals (DOAJ); JSTOR; or others. In some embodiments, the documents and data so identified are ranked or organized using preferences established by a user, with the documents then provided to one or more users for review. The User Interface may be for use in or in anticipation of a deposition proceeding.

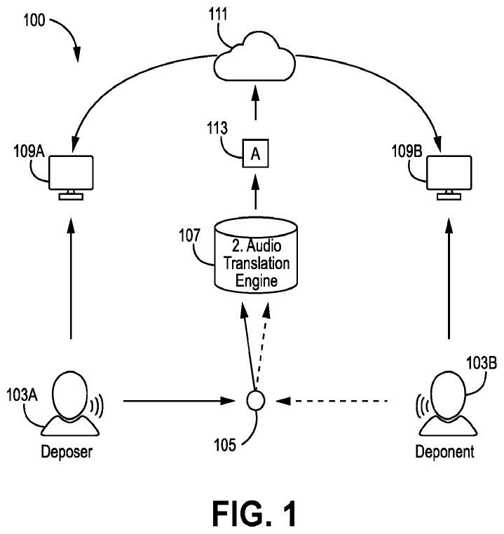

FIG. 1 is a conceptual diagram illustrating one example of an Automated Legal Proceeding Assistant (ALPA) system 100 according to one or more aspects of this disclosure. ALPA system 100 is an automated system that provides assistance that simplifies a legal proceeding, such as a trial or deposition, for participants in the legal proceeding. For example, ALPA 100 may enable the participants, for example deponents, attorneys, judges, and the like, to swear-in, automatically record testimony, generate transcripts using speech to text technology, and provide a smooth and seamless process to enable resolution of ambiguities in generated transcripts to create a final, official transcript of the legal proceeding sufficient to serve as evidence, if necessary. In some examples, ALPA system 100 may advantageously perform some functions typically performed by a human court reporter, such as the generation of realtime transcription.

System 100 described herein improves efficiency by eliminating the time-lag on receiving deposition transcripts. In some embodiments, the examples described are directed to a deposition legal proceeding, however one of skill in the art will recognize that the techniques described herein may be applicable to any type of legal proceeding that requires generation of reliable transcripts reflecting the content of what was said by whom, during the legal proceeding.

As shown in FIG. 1, ALPA system 100 includes an audio translation engine 107, at least one microphone 105, and at least one user interface 109A, 109B. In some embodiments, the audio translation engine 107 is local. In other embodiments, the audio translation engine 107 is located remotely, for example in a cloud-based server or remotely located server or computer. ALPA system 100 utilizes one more of microphones 105 to detect, capture, transmit and/or record sounds, including voices. The microphones 105 can be any one of numerous such devices known in the art, such as standalone microphones (whether “wired” or wireless) or devices that incorporate microphones or other audio technology, such as computers (laptops, smart phones, iPads) and the like, including computers which are augmented with external or removable microphones (e.g., microphones attached via USB).

As shown in FIG. 1, microphone(s) 105 are arranged to capture recordable audio of participants in a deposition proceeding. As shown, microphone 105 is arranged to capture audio reflecting statements made orally by deposer 103A, as well as deponent 103B. In other embodiments, the microphone can be arranged to preferentially capture the audio of a specific participant.

As also shown in FIG. 1, system 100 includes an audio translation engine 107. Audio translation engine 107 receives (directly or indirectly) from microphone 105 digital or other data reflecting audio of oral statements and other audible sounds made by deposer 103A and/or deponent 103B in the course of a deposition proceeding. Audio translation engine 107 processes and/or stores, for example in temporary memory such as Random Access Memory (RAM), or long term storage such as a magnetic hard disk or other long-term storage device (or, in other embodiments, otherwise accesses electronically) the received data reflecting audio recordings, and processes the data to generate a transcript 113 reflecting the orally communicated content of the deposition proceeding. Audio translation engine 107 generates the transcript 113 to include all (or substantially all) statements made by participants 103A, 103B on the record during the course of the deposition. In some embodiments, statements may be identified based on who said the statement (i.e., diarization) in a sequential or substantially sequential manner.

In addition, ALPA system 100 includes user interfaces 109A, 109B. User interfaces 109A-109B enable users, such as participants of the legal proceeding, and/or non-participants running or observing the legal proceeding (administrator, paralegal, remote attorney, etc.), to interact with system 100 during a deposition. In some embodiments, participants and/or non-participants may be located in the room or remotely. For example, user interfaces 109A, 109B may each comprise a computing device (laptop, smartphone, tablet computer) with a display and some form of input means (keyboard, mouse, touch-screen) for a user to receive information from system 100 and/or to provide input to system 100.

As shown in FIG. 1, audio translation engine 107 is coupled to a network 111, such as the internet. Network 111 enables communication between audio translation engine 107 and user interfaces 109, as well as to other components of system 100 not depicted in FIG. 1. For example, although not depicted in FIG. 1, system 100 may include one or more remote computing devices such as server computers accessible via network 111 that store data and or execute instructions associated with audio translation engine 107, user interfaces 109, or both.

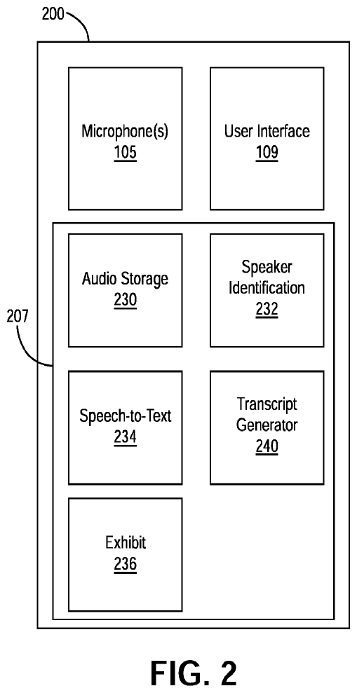

FIG. 2 is a block diagram depicting one example of an Automated Legal Proceeding Assistant (ALPA) 200 according to one or more aspects of this disclosure. As shown in FIG. 2, in some embodiments ALPA 200 includes an audio translation engine 207, at least one microphone 105, and at least one user interface 109. Microphone 105 includes any device or devices configured to capture an audio recording. User interface 109 include any device that enable users, such as participants in a legal proceeding, to interact with ALPA system 200, for example to provide input or receive feedback from ALPA system 200.

As shown in FIG. 2, audio translation engine 207 includes an audio storage module 230, a speaker identification module 232, a speech to text module 234, and a transcript generator module 240. As described herein, each of modules 230, 232, 234, 240 include software instructions stored in a tangible storage medium and executable by a processor of a computing device. In some examples, each of modules 230, 232, 234, 240 are executable on a computing device local to where a legal proceeding such as a deposition takes place. For example, one or more of modules 230, 232, 234, 240 may execute on a device that serves as user interface 109, which may be a smartphone, tablet, laptop computer, desktop computer, or the like. In other examples, one or more of modules 230, 232, 234, 240 include software instructions executable on a processor of one or more computing devices located remotely, such as one or more server computing devices coupled to audio translation engine 207 over a network such as the internet. In operation, ALPA system 200 allows a user to initiate the deposition proceeding. As an example, ALPA system 200 provides a user with a visual indication, such as through a display of user interface 109, with an option to commence the deposition proceeding. In advance of, or contemporaneously to the start of a deposition, the ALPA system 200 may request or permit the identification of deposition participants. In some embodiments, the deposition may proceed with or without a traditional court reporter. In some embodiments, a court reporter may independently create a record of the deposition stenographically (for example to create an official, certified transcript) while the ALPA system creates a second record utilizing STT technology via the audio translation engine 107.

Deposition participants may include one or more deponents, or one or more deposing attorneys, one or more representing attorneys who represent the deponent in the deposition, or one or more other participants, such as witnesses or, in the course of courtroom proceedings, judges or magistrates or other court personnel, any or all of whom may be located remotely from each other, but each of which may be participating in the deposition via remote access means, including via internet, telephone or remote video conference means, such as SKYPE, ZOOM, WebEx, WhatsApp, Line, Google Hangouts, WeChat, Talky, ooVoo, Rakuten Viber or similar. ALPA system 200 may also request or permit the input of other information associated with the deposition, such as a court case number, attorney docket number, filing date, other information that identifies the subject matter of the deposition proceeding. ALPA system 200 may also request or permit the input (or receive), though a user interface 109, any other information that is typically reflected or reflected in a deposition transcript, including information associated with the confidentiality level or presumed confidentiality level of the subject matter of the proceeding, information regarding individuals present but not speaking at the deposition, the location of the deposition, or the law firms and companies represented by individuals present, in person or telephonically, at the deposition (whether speaking or assigned a microphone or not). In some embodiments, ALPA system 200 may also request or permit, though a user interface 109, users to contemporaneously communicate and/or share data or documents with other users of the system, such as to suggest lines of questioning, identify documents related to one or more portions of a transcript or speech, and alter, comment on, mark up, and share those documents utilizing user interface 109.

In some embodiments, ALPA system 200 will execute an initialization procedure to prepare for recording and generating a transcript of the deposition proceeding. As part of the initialization procedure, ALPA system 200 may determine a list of participants in such a manner that system 200 may differentiate between different speakers during the deposition proceeding, so that an accurate transcript can be generated. For this purpose, transcript generation engine 207 includes a speaker identification module 232, which identifies respective participants of the deposition. In some embodiments, ALPA system 200 includes a plurality of microphones 105, each of which are assigned to a particular deposition participant. In some embodiments, speaker identification module 232 uses the microphone assignments themselves to associate recorded audio with a particular speaker. For example, each participant may wear, or keep in close proximity, a microphone 105. As examples, the participants may wear a microphone (e.g., secured to a user's shirt collar, earpiece, etc.), or may use a computing device including a microphone, such as a smartphone or tablet, or a standalone microphone device arranged in proximity to the participant. In other embodiments, ALPA system 200 may be configured to convert speech to text without identifying speakers.

In some embodiments, system 200 may prompt participants, via user interface(s) 109, to speak a word or phrase, such as their name. Speaker identification module 232 may then determine whether it can accurately identify the spoken voice of each participant speaker. In some examples, if speaker identification module 232 is unable to accurately separate one speaker from another, speaker identification module 232 may request, via user interface(s) 109, that one or more participants change their microphone configuration. For example, speaker identification module 232 may request that one or more participants move further away from other participants, or that one or more participants use a different microphone.

According to some other examples, ALPA system 200 may not only use assigned microphones 105 to identify different speaker participants from one another. According to these examples, ALPA system 200 may instead, or in addition to identifying speakers based on a microphone that recorded audio, process (e.g., using audio captured from one microphone only (capturing audio from multiple deposition participants), or in another embodiment several microphones 105) the captured audio to identify respective speakers in audio recordings. According to these examples, speaker identification module 232 identifies speaker participants based on a number factors alone or in combination, including voice pitch height, pitch modulation, pitch range, speech rate, fluency, vocabulary, grammar, usage and other speech patterns or other data. Additionally, speaker identification module 232 may identify a user by other vocal traits, including measurements of the speakers use of vowels, including (for example) average and standard deviation for fundamental frequency; period to period frequency; period to period amplitude variation; and GNE (glottal to noise excitation ratio), as examples. According to these examples, speaker identification module 232 is configured to store one or more speaker profiles in memory or access existing profiles of known speakers from prior depositions (as an example). According to these examples, during an initialization procedure of ALPA 200, speaker identification module 232 requests, using user interface(s) 109, that each participant to the deposition identify themselves, for example through spoken word, or text input via user interface(s) 109, or via other means. Speaker identification module 232 then determines whether it has access to a stored profile for each deposition participant sufficient to identify them based on recorded speech. If speaker identification module 232 does not include a stored profile for a deposition participant, it may request that the missing participant supply information allowing speaker identification module 232 to create a profile. For example, speaker identification module 232 may, via user interface(s) 109, request that the missing participant speak several predefined words or phrases from which speaker identification module 232 can extract one or more speech parameters or properties to generate a profile for that user.

In some examples, speaker identification module 232 may be generally configured to utilize identification of a microphone or microphones that captured audio to identify which deposition participant is associated with recorded audio segments, but may utilize processing to identify speaker(s) based on stored user profiles as a fail-safe. For example, system 200 may include a plurality of microphones each assigned to a deposition participant, and one or more “fail-safe” microphones not assigned to a particular deposition participant but arranged to capture audio during a proceeding. According to such examples, if for some reason speaker identification module 232 is unable to identify a speaker associated with an audio segment, speaker identification module 232 may process audio recorded by the fail-safe microphone(s) to identify speakers associated with the recorded audio.

In some examples, whether speaker identification module 232 is configured to identify respective speaker participants of the deposition proceeding based on microphone 105 assignments, or based on processing captured audio to determine an identity of respective speaker participants based on comparison to a predefined profile, or both, as part of the initialization procedure speaker identification module 232 determines whether each deposition participant is a valid deposition participant whose speech may be identified in audio recordings. In some embodiments, the speaker identification module may identify, during the course of a deposition, the speech of someone not pre-identified as being a participant in the deposition, but may nevertheless, and in conjunction with system 200, record and translate their speech events. In some embodiments, the system is not configured to identify specific speakers and assign to them speech, but is instead configured to detect and convert into text the speech of any speaker during the deposition.

In some embodiments, information solicited by the initialization procedure of ALPA 200 will be input prior to the deposition though user interface 109, and as a result, the deposition participants will not need to enter information or establish a user profile for use by speaker identification module 232 as part of the deposition proceeding itself. For example, in advance of the deposition, a legal assistant or other user may pre-enter information, including the names of the participants, the firms or companies they represent, link the participants with them any pre-existing voice profiles if one or more deposition participants have previously used system 200, input the location of the deposition, the case name and caption, the deponent name, etc. In some cases, such information will be entered well in advance of the deposition proceeding itself. In this manner, deposition participants, and other users, may proceed immediately with the deposition proceeding itself, which may beneficially save time.

In some examples, as part of the initialization procedure, system 200 requests required participants of the meeting to administer an oath. Accordingly, system 200 outputs audio instructions or presents on a display (of user interface 109) a textual description of the oath, and request signatures or the traditional vocal assent to proceed under oath from the required participants. In some examples, signatures may be received via the user(s) writing their signatures on a touch-screen display of user interface 109. Once speaker identification module 232 has completed the initialization procedure so that it is prepared to identify the source of spoken word for each identified participant in an audio recording, the deposition proceeding may commence. Accordingly, ALPA 200 may, via user interface(s) 109, request confirmation from one or more participants that the deposition should commence.

Once ALPA 200 receives an indication that the deposition should commence, the parties may commence the deposition, for example, the deposing attorney may ask questions to the deponent, the deponent may answer, and the deponent's attorney may interject with objections or the like.

As the deposition proceeds, audio storage module 230 receives an output signal from microphone(s) 105 and stores one or more audio recordings representing what was said at the deposition in memory. For example, audio storage module 230 may compress received audio recordings to reduce size, encrypt received audio recordings to ensure security, or otherwise process audio recordings. In some examples, audio storage module 230 stores a single audio recording that represents an entire deposition. In other examples, audio storage module 230 stores a plurality of audio files that represent captured audio from multiple microphones 105. In some examples, audio storage module stores audio recordings with a plurality of timestamps that identify when a particular recording was made.

In some examples, as audio storage module 230 operates to store recorded audio, speaker identification module 232 analyzes recorded audio (e.g., based on which microphone 105 recorded the audio, or based on matching with stored user profiles as described above), so that each audio recording is stored by audio storage module 230 with a corresponding identification of the source of the recording. In some examples, audio storage module 230 stores audio recordings on a memory storage device (e.g., Random-Access-Memory, hard disk storage, flash memory storage) on a computing device local to the deposition proceeding, such as user interface(s) 109. In other examples, audio storage module 230 stores audio recordings on a computer server located elsewhere and connected via a network such as the internet.

In some examples, audio storage module 230 is operable to establish confidentiality for stored audio recordings. According to these examples, audio storage module 230 may store recorded audio with one or more confidentiality markers that system 200 may use to ensure that only those parties (e.g., respective deposition participants) may access information, such as audio recording(s), that the deposition participant is authorized to access.

In some examples, system 200 may be configured to control access by assigning confidentiality markers to other data used by system 200, for example identification of deposition participants or other parties to a court proceeding, exhibits, user voice profiles, or any other data used by system 200. In this manner, system 200 may enable respective parties to easily access data or information they are allowed to access, however maintain confidentiality that would normally be maintained in a traditional court or deposition proceeding.

As also depicted in FIG. 2, ALPA 200 further includes a speech-to-text (STT) module 234. STT module 234 analyzes audio recordings transmitted to it (or stored and transmitted to it by audio storage module 230) to convert the content of spoken word to written text that may be used to generate a transcript of the deposition proceeding. STT module 234 may include one or more executable software modules that are configured to analyze an audio recording to identify features in the recording that enable STT module 234 to output one or more text files that represent what was said in the audio recording(s). In some embodiments, the STT module may be functionally provided by a third party speech-to-text service. In some embodiments, the STT module 234 may be executed on a local system or a remote system. In other embodiments, functions performed by the STT module 234 may be implemented by a human transcriber—once again located either locally at the site of the deposition or remotely. In embodiments in which the human transcriber is located remotely, audio segments are communicated via wired or wireless means to the remote location and converted to audio signals for the human transcriber. The transcript generated by the human transcriber is communicated via wired or wireless means to the participants of the deposition for display. As described elsewhere, the real-time transcript may be displayed to some or all of the deposition participants as well as to non-local users granted access to the deposition transcript. In some embodiments, a hybrid STT system is employed to generate a real-time transcript that incorporates a combination of speech-to-text (STT) software and human transcription reviewers. In some embodiments, the STT software (located remotely or locally) is utilized to convert audio recordings to a real-time transcript. Subsequently, the human transcription reviewers review the real-time transcription generated by the STT software and the audio recording associated with the proceeding and make corrections where necessary. The corrected real-time transcript may then be communicated or display to participants of the deposition (whether located locally or remotely). In other embodiments, other means may be utilized to generate the real-time transcript.

Speaker identification module 232 further operates to identify in audio recordings stored by audio storage module 230, a speaker source for each word or phrase. As described above with respect to the initialization phase, in some examples speaker identification module 232 identifies speakers based on which of a plurality of microphones recorded particular audio (or recorded the audio the loudest). In other examples, speaker identification module 232 uses one or more stored profiles representing deposition participants in order identify a speaker in recorded audio. In other examples, speaker identification module 232 identifies speakers in recorded audio based on both an assigned microphone and one or more stored profiles.

As also shown in FIG. 2, ALPA 200 further includes an exhibit module 236. Exhibit module 236 is configured to manage exhibits as part of the deposition proceeding, such that the exhibits are easily accessible by participants in the deposition, and such that their use may be reflected in a generated transcript. For example, prior to or during a deposition proceeding, a participant or other user (e.g., legal assistant or paralegal), may submit to system 200 via user interface 109 one or more documents that are identified as exhibits associated with a deposition proceeding or case. During a deposition proceeding, exhibit module 236 may make one or more submitted exhibition documents available to the deposition participants, for example via a display of user interface(s) 109. Exhibition module 236 may capture data associated with use of the exhibit, for example exhibition module 236 may capture a timestamp associated with presentation of each exhibit document, and/or may associate the presentation of the exhibit with audio files, or portions of audio files, that were captured while the exhibit was being presented to the deposition participants. In this manner, data associated presentation of exhibit documents may be used to generate a transcript that reflects the discussion of the exhibit documents.

As also shown in FIG. 2, ALPA 200 further includes a transcript generation module 240. In some embodiments, transcript generation module 240 is operably configured to receive the output of STT module 234, and, where present, the output of speaker identification module 232 and/or exhibit module 236, to generate a transcript that reflects the deposition proceeding including, in some embodiments, what was said during the deposition proceeding, and who said it, and what exhibits were discussed during the deposition. For example, transcript generation module 240 receives text from speech to text module 232 reflecting what was said in one or more recordings stored by audio storage module 230, an indication of which deposition participant spoke the words associated with the received text from speaker identification module 232, and/or an identification of one or more exhibit documents that were presented and discussed during the deposition, and when they were presented and discussed. Transcript generator 240 may review timestamps or other information contained in stored audio, and piece together a transcript reflecting sequentially the content of what was said, and by whom, during the deposition proceeding. Transcript generator 240 may also use additional information in generating a transcript, for example, when the parties went on and off the record (e.g., reflecting breaks in a deposition proceeding such as a lunch break or overnight break when a deposition proceeding spans multiple days), the text of an oath administered to deposition participants, information that is reflected in a cover page of the transcript, such as identification of a court case number, attorney docket numbers, participant names, law firms involved, an administrator's name, etc.

In some examples, transcript generator 240 may generate portions of a transcript in real-time during a deposition proceeding. According to these examples, as audio storage module 230 receive and stores audio data from microphone(s) 105, STT module 234 converts the stored audio data into a text representation, and speaker identification module 232 associates a deposition participant to each converted text representation. In other representations, audio is transmitted in real time to a STT module (whether locally or remotely located or cloud based) for speech to text conversion, but the audio files are not otherwise stored. In some embodiments, the transcript generator 240 sequentially generates transcript portions as the deposition proceeding takes place. In some embodiments, these transcript portions can be displayed to any participant having access to the system via a user interface. In some examples, by sequentially generating transcript portions in real time, transcript generator 240 can quickly generate a final transcript of the deposition that is available to the deposition participants immediately upon conclusion of the deposition proceeding. In some examples, the initial transcript generated upon conclusion of the deposition may be a “rough” version of the transcript that includes some errors. System 200 may be configured to enable deposition participants to resolve such errors, as described in further detail below.

In some examples, transcript generator 240 is operable to, while a deposition proceeding is taking place, output via user interface(s) 109, generated transcript portions for real-time review by participants. According to these examples, transcript generator 240 may receive from a user confirmation and/or updates to generated transcript portions during the course of the deposition. In some such examples, providing for real-time review of transcript portions during the course of a deposition may enable transcript generator 240 to generate a final transcript accepted by all deposition participants faster than if review of a generated transcript and resolution of ambiguities in a generated transcript take place after a deposition proceeding has concluded. In some examples, the real-time transcript is utilized—as discussed in more detail below—to generate search queries utilized to locate documents relevant to the deposition in real-time. In some embodiments, search queries are comprised of terms or collections of terms selected directly from the real-time transcript.

In some examples, system 200 may be configured to notify deposition participants when the deposition proceeding is “in-session” and testimony is being recorded. For example, system may use user interface(s) 109 to notify deposition participants when a deposition has commenced, when paused, and when complete via a display screen of the user interface(s). In one embodiment, where an exhibit is paused, the system is configured to identify the time when the deposition has been paused, and is further configured to later include a notation in a transcript of when the deposition was paused and/or when the deposition recommenced, along with the time for both. In other examples, system 200 may include a light such as a light emitting diode (LED) device coupleable to system 200 via user interface(s) 109. As one specific example, such a light device may comprise a red light and a green light. System 200 may operate the green light when the deposition is in progress and audio is recorded by microphone(s) 105, and operate the red light when the deposition is paused, has completed, or is otherwise not in-session.

Upon completion of the deposition (e.g., as indicated by a deposition participant), in embodiments where the system is utilized to create an official transcript, transcript generation module 240 may generate a document that includes a transcript that generally reflects what was stated during the deposition by the deposition participants. Once the transcript has been generated, it may be sent to each participant to the deposition, such as the deponent and respective attorneys, via user interface(s) 109 (e.g., a smartphone or tablet) for review for accuracy and ultimately final approval.

In some examples, ALPA system 200 is configured to resolve any ambiguities in the generated deposition transcript. For example, ALPA system 200 may identify any portions of the deposition transcript for which STT module 234 was unable to accurately determine the content of what was spoken, or for which speaker identification module 232 was unable to accurately identify a speaker. According to these examples, ALPA system 200 may send one or more deposition participants a deposition transcript proactively identifying each ambiguity, and request confirmation that the ambiguity-labeled content is accurate, or that the respective participant(s) supply a correction. In some examples, system 200 may send the deposition transcript with a time limit in which the participant(s) are required to respond. For example, system 200 may request (via email, via 109, or other) that the participant type or speak what that participant believes was actually said during the deposition, after which those corrections themselves may be reviewed by one or more individuals for accuracy themselves, and potentially contested, if there is a disagreement among the parties. In some examples, system 200 may be configured to analyze an identified ambiguity and provide one or more suggestions to resolve the ambiguity, which may be selected by the participants.

In some examples, audio storage module 230 maintains data reflecting at least a portion of audio captured during a deposition proceeding in a manner that the recorded audio is associated with generated deposition text. In this manner, the respective deposition participants can use such an audio recording to reconcile any ambiguities in a transcript or transcript portion generated by transcript generator 240.

In some examples, if all deposition participants provide the same answer in response to identified ambiguity(ies) (or no ambiguities were detected), transcript generator 240 generates a final transcript that reflects the corrected ambiguity and sends the final transcript to all participants, notifies the participants that it is finalized, or makes it available via 109. In other examples, where the deposition participants do not agree on an identified ambiguity, transcript generator module 240 generates a transcript that identifies the ambiguity as “in-dispute,” and sends the generated transcript to all participants or otherwise makes it available, as stated above.

ALPA system 200 described above provides numerous advantages in comparison to prior techniques for recording deposition transcripts that require a trained and licensed court reporter. For example, using ALPA system 200 may enable parties to a deposition or other legal proceeding to generate a transcript with less cost, because it is not necessary to hire an expensive court reporter to perform the task of generating a transcript. In addition, ALPA system 200 may work faster, and more efficiently, than a human court reporter. For example, ALPA system 200 may identify speakers and convert speech to text in real-time, thereby allowing a transcript to be generated immediately after the legal proceeding commences, in comparison to a court reporter who may take days or weeks to review manually typed text and generate a final transcript. In addition, ALPA system 200 may provide for better accuracy than a human court reporter, and enables fast and reliable correction (or at least identification) of ambiguities in generated transcript subject matter in a reliable manner which avoids disputes between deposition participants.

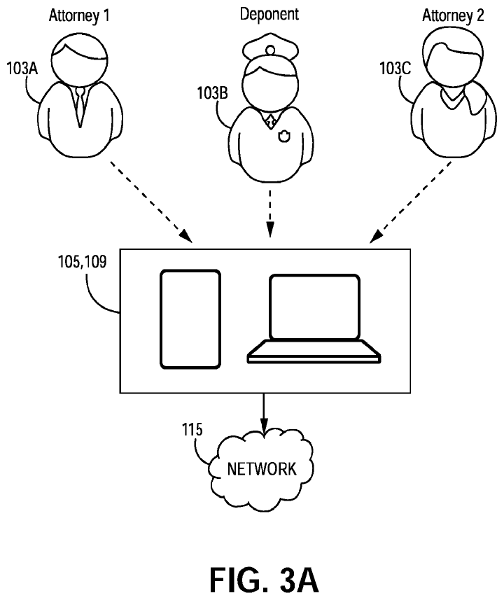

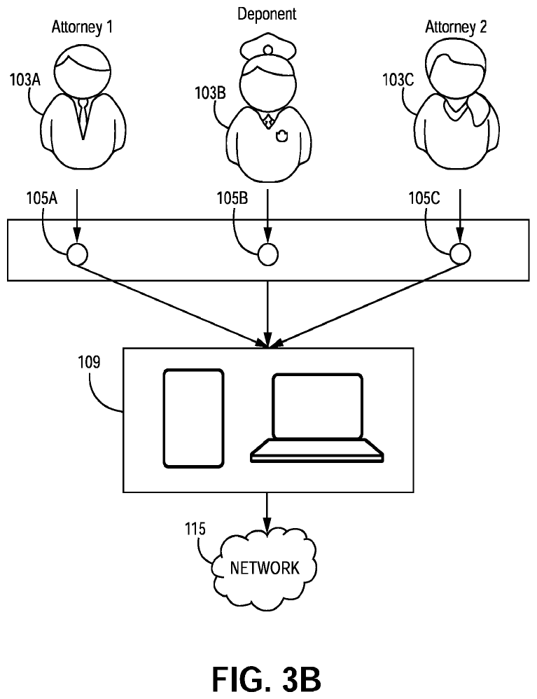

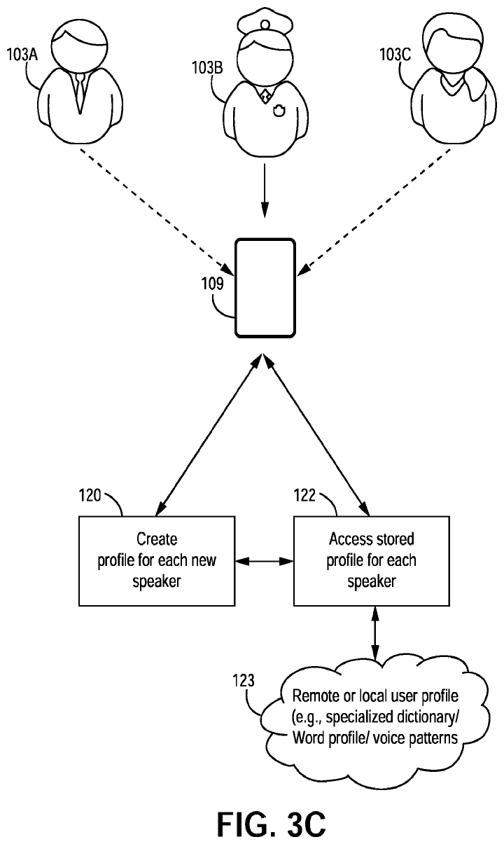

FIGS. 3A to 3C are conceptual diagrams that depict a plurality of deposition participants, in this instance a policeman 103B, and two attorneys 103A, 103C, their speech events being detected by a microphone incorporated into one of a computer or smart phone, in one embodiment, or in an alternative embodiment, by wired or wireless listening devices (microphones, not depicted here) which are themselves in wired or wireless communication with a smart phone or computer in accordance with some embodiments of the invention.

As shown in FIG. 3A, the speech of each of deponents 103A-103C is captured by a microphone 105 associated with a user interface 109 (e.g., a computing device such as a laptop, smartphone, tablet computer). According to such an embodiment, speaker identification module 232 identifies based on speech characteristics an identity of respective speakers in the recorded audio.

FIG. 3B depicts an alternative embodiment, where each deposition participant is associated with specific microphone 105A-105C. According to this example, each of microphones 105A-105C is coupled to a computing device (e.g., user interface 109), which are in turn coupled to a network 115 such as the internet. According to the example of FIG. 3B, where each deposition participant 103A-103C is associated with a particular microphone 105A-105C, speaker identification module 232 may identify a speaker in recorded audio based on which microphone recorded a particular audio segment. Alternatively, the speaker identification module 232 may identify a speaker based on one of the other voice recognition means discussed above.

FIG. 3C depicts one example where system 200 captures speech of deposition participants via a microphone 105 of a user interface device 109 (smartphone). As shown in FIG. 3C system 200, for each participant 103A-103C, system accesses one or more stored profiles 122 to associate recorded audio with a particular participant 103A-103C. If system 200 does not already have access to a stored profile, system 200 may create a profile for each new speaker 120, for example by requesting that the new user(s) read or repeat one or more phrases and analyzing the spoken phrases to create a user profile 122. In some embodiments a new user may not read or repeat a phrase, but a user profile will be generated dynamically during the course of the deposition. In some examples, user profiles may be stored locally (e.g., on user interface device 109), or remotely via a server computer coupled to system 200 via a network such as the internet.

The audio translation engine 207 may be remote, and audio data (when storage is required) may be stored locally or remotely, including in a cloud-based environment. The audio data may be stored in a location proximate to or remote from the audio translation engine, and the transcripts derived therefrom may also be stored locally or remotely from the audio translation engine and/or the audio-enabled devices. In one embodiment, the deposition data, including voice data, may be stored directly on an iPhone or other smart phone or computing device, which may or may not be configured as an audio translation engine 207 and/or a differentiation and association engine, and/or a server, in one embodiment. In another embodiment, where the smart phone or computing devise is not so configured, one or more of these functions may be remotely performed on speech data recorded and/or transmitted during a deposition, or recorded during and transmitted after a deposition.

In one embodiment, audio translation engine 207 (e.g., speech to text module 234, and in some embodiments in conjunction with 234) uses voice recognition technology to identify words and create a transcript based on recorded audio file(s). Audio translation engine 207 detects the voice profile of a specific speaker that is either stored locally or which can be accessed from a remote database utilizing network means, and identifies the speech acts of that specific individual as distinct from any other speakers. In another embodiment, where the system 200 is not equipped to identify a specific speaker by a stored or otherwise known audio profile, the identity of that speaker can be identified to the system 200 by generating a new profile such that speech from that individual is thereafter associated with that individual.

In some examples, audio translation engine 207 (e.g., speaker identification module 232) parses individual voices from a recording containing the speech of multiple individuals, and individuals may be identified through a variety of means, including by data from a user-specific voice profile, which may include data that can help identify the speech acts of one speaker from the sometimes contemporaneous speech acts of other speakers.

Audio translation engine 207 (e.g., speaker identification module 232) may identify a participant speaker based on one or a plurality of factors, including voice pitch height, pitch modulation, pitch range, speech rate, fluency, vocabulary, grammar, usage and other speech patterns. Additionally, audio translation engine 207 may identify a user by other vocal traits, including measurements of the speakers use of vowels, including (for example) average and standard deviation for fundamental frequency; period to period frequency; period to period amplitude variation; and GNE (glottal to noise excitation ratio), as examples. Other examples include pronunciation of known words, accent, intonation, speech speed, and user-specific word emphasis, or other physical, behavioral voice traits. Audio translation engine 207 (e.g., speaker identification module 232) may also identify a specific speaker by that speaker being pre-identified manually by anyone authorized to access 109.

Any other vocal or sound characteristic for a speaker may be utilized by transcript generation engine 207 (e.g., speaker identification module 232) without deviating from the scope of the invention. In one embodiment, and as an example, a plurality of speakers are identified as participating in a deposition or a court hearing. For each such speaker, one or more outlying speech traits are identified for those individuals, and in some preferred embodiments, the speech traits are identified based on how meaningfully they differentiate that speaker from the other speakers in the room.

As one example, high pitched voices can be meaningfully and reliably differentiated from a lower pitched voice. And, in addition to mere speech acts being identified as speech acts (sounds being identified as words as opposed to sounds being identified as sounds (e.g. paper moving, chairs shifting, ambient noise, etc.), the words so identified may be further identified as being uttered by a particular individual (in preferred embodiments as a known individual).

In one embodiment, one or more users in advance of a deposition (for example) will utilize system 200 (e.g., speaker identification module 232) to identify themselves by name, and may associate themselves with a known voice profile (locally or remotely stored; accessible in real time or accessible post-deposition). In another embodiment, system 200 (e.g., speaker identification module 232) may utilize microphone(s) 105 themselves to identify a speaker participant among participants of the deposition.

For example, system 200 (e.g., speaker identification module 232) may associate one microphone device 105 with each deposition participant, and identify disparate speakers based on which microphone 105 device recorded the audio. For example, a specific audio input may be associated with one distinct individual or with a discrete set of individuals. In such an embodiment, a speaker may wear a microphone 105 that clips on to clothing (e.g., a shirt collar), or a body part (e.g., an ear piece), and the system 200 is configured to identify the speech events detected by that microphone as being the speech events of the speaker wearing the microphone, as distinct from the speech events of other speakers, who themselves may be wearing similar, user-specific microphones (as recognized by the system). In still other examples, system 200 may associate microphones 105 that are not necessarily worn by participants, for example tabletop or other microphones arranged in proximity to each respective speaker may be used to differentiate between the speech of respective deposition participants.

In some cases a voice profile and the resulting translation will enjoy exceptional accuracy due to repeat use of system 200, and the ongoing capture and analysis of individual-specific and matter-specific (e.g., case specific) data. Repeat use of the system enables the audio translation engine 207 to draw upon a larger body of data (of the kind identified above), which in turn will yield more accurate transcripts. In addition, audio translation engine 207 may enable post-deposition correction(s) via 109A-B of deposition transcripts that have been, for example, incorrectly or incompletely translated (for any reason) or where a portion of the transcript has been pre-flagged by 207 as being of questionable accuracy, for example due to the use of rare or hard to translate words, proper names, etc. In another embodiment, audio translation engine 207 may ask a user, in advance of a legal proceeding, to read a standardized transcript that will be utilized by the translation engine 207 to differentiate that speaker from other speakers, by gathering voice data that assists in assigning speech acts to specific speakers in a room (e.g., voice pitch height and modulation, pitch range, speech rate, fluency, vocabulary, grammar, usage and other speech patterns).

In some instances, system 200 may incorporate, or access via networked means, data obtained from discovery and in some embodiments, one or more discovery databases (or non-indexed databases) associated with the case at issue in the deposition. In another embodiment, the system may incorporate or access via networked means, data associated with different cases, which may nevertheless be related to the instant case because they contain information from one or more employees of a company, similar subject matter, or other related data. Such databases, including indexed discovery databases, typically include documents and data regarding those documents (e.g., metadata) that are produced by parties during the course of a proceeding. Such databases (such as eDiscovery-type databases such as those offered by Relativity, DISCO, and many others) the documents and information they contain may be prepared utilizing a variety of means. For example, witnesses in a case or other individuals in possession of discoverable information relevant to a case often produce relevant documents and things in a variety of forms, including: paper discovery, including notebooks, notepads, sketches, and the like and electronic discovery (i.e., eDiscovery, including information downloaded from servers, including email servers, backup tapes, local hard drives or flash drives). Electronically stored discovery may include documents that exist in many different file forms, including files utilized by word processing programs (e.g., doc, docx, dot files), excel files (xls, xlsx), pdf files, tif image files, text files (txt), and photo image files (jpe, jpg, jpeg, etc) among many others. In some instances, these files are gathered from document custodians and stored, and transformed/processed or analyzed using a variety of methods. Image files and pdf files, for example, may undergo optical character recognition (OCR) processing to determine whether they contain text, and convert the text to an ASCII format. Metadata associated with any file may be stored in order to identify later who wrote the document and when, when it was edited any by whom, and to whom it was sent (as examples). Exemplar metadata fields include, as examples, author, recipient, to, cc, bcc, custodian, domain, folder, path, from, subject, and text fields, among others. Physically produced “hard” documents may be scanned to transform them into an electronic format which can then undergo further processing (e.g., OCR processing). In one embodiment the database may utilize text-based (also called Native extraction) indexing.

Documents may be processed, stored and accessed (not necessarily in that order) in a variety of ways without departing from the scope of the invention including via local means or via hosted computing systems over the internet. Documents may be processed in any manner that facilitates searchability without departing from the scope of the invention. Documents may be stored by any means, including locally (e.g., on dedicated drives and servers) or in cloud-based environments (including, for example, public, private and hybrid cloud-based environments, among others).

The collective data may then be indexed or undergo other processing, such that a document reviewer may then efficiently search the documents and data in order to locate information and facts relevant to a litigation case. In a case involving asbestos, for example, the indexed documents may be searched for key words or the names of key individuals, such that the documents may be readily identified.

The system may also incorporate or access via networked means other outside databases, including third party databases, bibliographic databases, or other proprietary databases (to name a few). Such databases may include IEEE Xplore, Scopus, Web of Science, PubMed (biological and medicine references); ScienceDirect; Directory of Open Access Journals (DOAJ); JSTOR; or others. See also: https://en.wikipedia.org/wiki/List_of_academic_databases_and_search_engines.

For example, in the embodiment shown in FIG. 17, ALPA interacts with an eDiscovery system to locate documents relevant to the proceeding. In some embodiments, eDiscovery system is located locally (i.e., as part of ALPA 200). In other embodiments, eDiscovery system may be located remotely, wherein communication between ALPA and eDiscovery system is via a network. At step 1702, system displays the real-time transcript via user interface 109. At step 1704 a user selects one or more words from the real-time transcript. In some embodiments, the selected words are displayed in a search window on the user interface 109. At step 1706 the selected word or words are communicated to the eDiscovery server as the basis of a search. In some embodiments, the selected word or words are utilized as part of a keyword search of the eDiscovery server. In other embodiments, the configuration of search terms is utilized to determine the type of search to be conducted. For example, for a single search term a typical keyword search may be selected. A plurality of search terms may result in other types of searching being utilized, including but not limited to Boolean, Proximity, Stemming, Fielded, Semantic, conceptual or Fuzzy logic type searches, and metadata. In some embodiments, ALPA determines the type of search to be conducted based on the word or words selected. In other embodiments, the word or words are communicated to the eDiscovery system and the eDiscovery system makes the determination of the type of search to conduct based on the search terms received. At step 1708, eDiscovery system conducts the search of one or more databases based on the received search terms. In some embodiments, metadata associated with the eDiscovery system is utilized to aid in locating relevant results. At step 1710, search results are organized/indexed. For example, in some embodiments this may include organizing relevant documents by document type (e.g., emails, text documents, etc.), author, date, etc. At step 1712, search/indexed results are communicated to the ALPA for display. In some embodiments, to minimize the transfer of large amounts of data between eDiscovery system and ALPA (in particular if located remotely from one another and connected via a network), indexed search results are communicated to ALPA, not the underlying documents. In this embodiment, documents referenced in the indexed search results are communicated to ALPA only in response to a user selecting the document to view.

In the context of the instant disclosure, system may be linked to a discovery database for a particular case, and the data there obtained utilized by system, among other things, increase the accuracy of speech to text translation by STT module 234. By way of example, system may be utilized to facilitate the deposition of a witness, Mr. Okerlund. System may then query the discovery database of documents as a whole to identify the use of infrequently used terms, or in preferred embodiments documents specifically associated with Mr. Okerlund (e.g. associated utilizing metadata identifying emails and documents authored by Mr. Okerlund), and those documents may be analyzed by the system to identify language patterns particular to Mr. Okerlund, or the use of unusual or infrequently used words that have been used by Mr. Okerlund. STT module 234 may identify such words (in advance, during or after a deposition) as potential candidate terms for words spoken by Mr. Okerlund during his deposition that may be challenging to translate. More broadly speaking, system 200 may query the database as a whole to identify terms not typically present in everyday speech (and therefore more difficult to translate), but which may be used more frequently in a specific industry (e.g., complex pharmaceutical terms used in the context of a pharma patent dispute, for example).

Examples include difficult words, terms, names, places, chemical names, or other problematic terms that may come up in association with a case. Where, for example, a document repository contains references to uniquely-named places (e.g., Punxsutawney, Pennsylvania) or difficult biological, technical, scientific or chemical terms, (e.g., polysaccharides, immunoglobulin, dodecahedrane and the like) or any term (local idiom, for example) not commonly used in everyday speech, system may proactively flag such terms from, for example, an the indexed document production database. Audio translation engine 207 (e.g., speech to text module 234) may subsequently utilize these terms to increase the accuracy of the translation. In the same vein, system may similarly index the word content of depositions associated with a case, such that uncommon or difficult words that have come up in the first (or earlier) deposition in a matter may be utilized to increase the accuracy of translations used in subsequent depositions.

In another embodiment, system may produce a transcript of a deposition that contains links from words in the deposition transcript to actual documents in an indexed discovery database where those same words occur. The system may be utilized to produce a complete deposition transcript of Mr. Okerlund that is more accurate and usefully cross-referenced to an indexed database of discovery documents. In one embodiment, the transcript will be more accurate where Mr. Okerlund references the city of Punxsutawney (correctly identified by the system 200 as “Punxsutawney” in the converted transcript as opposed to “punks and tawny” due to the fact that the term “Punxsutawney” was among those identified in the indexed discovery database as being an uncommonly used term occurring multiple times in associated documents (e.g., via metadata) with Mr. Okerlund). Moreover, utilizing user interface 109, a user may click the mouse on uncommon terms in the electronic transcript (or terms identified by a user of the system 200), and the system will query or otherwise access the indexed discovery database to identify documents where that same word or phrase occurred. Thus, a user of the system may access Mr. Okerlund's deposition transcript, click on the term “ Punxsutawney” and system 200 may identify specific documents in the discovery database where this term occurred, and in preferred embodiments may call out in particular those documents specifically associated with Mr. Okerlund (e.g., Mr. Okerlund's emails, identified via metadata) where that term occurred. Where ALPA has active access to such an indexed discovery database during the course of a deposition, system may dynamically search for documents in the discovery database by key word, and in such a way additional documents may be identified for use by an attorney utilizing ALPA during a deposition.

For example, in the embodiment shown in FIG. 18, ALPA communicates with eDiscovery system to improve the operation of the speech-to-text (STT) module 234. At step 1800, a deposition proceeding is initialized. In some embodiments, the initialization happens ahead of the deposition itself. In other embodiments, the initialization may happen at the start of the deposition proceeding. In some embodiments, initialization may include identification of the case associated with the deposition. In some embodiments, initialization may include identifying the participants of the upcoming deposition. At step 1802, in response to the initialization request, the eDiscovery system performs a search of relevant documents. In some embodiments, relevant documents may include all eDiscovery documents associated with a particular legal proceeding. In other embodiments, it may include only those documents identified as particularly relevant (e.g., documents included as part of exhibits, etc.). In some embodiments, the search identifies terms not included in the speech-to-text (STT) library. In some embodiments, this requires eDiscovery system to have access to or a copy of the STT library. In other embodiments, the search identifies terms that occur frequently in the searched documents. At step 1804 the identified terms are communicated to ALPA. At step 1806, the STT module 234 stores a copy of the identified terms and at step 1808 utilizes the identified terms to aid in converting speech to text. For example, in some embodiments the STT module 234 utilizes the stored terms in response to an audio segment that cannot be converted to text utilizing the STT library. In other embodiments, STT module 234 may assign confidence levels associated with converted texts, wherein if the confidence levels falls below a defined threshold with respect to a particular term then reference is made to the identified terms to determine whether one of the identified terms is a better fit. At step 1810 the real-time transcript is displayed. In some embodiments, for those terms translated to text utilizing the infrequently used terms received from the eDiscovery system, a link is created in the transcript that identifies those documents from which the word was identified. In some embodiments, this may aid parties in verifying that unusual terms are correct.

As described above, audio translation engine 207 may receive an indication to start a deposition proceeding from a user, and perform an initialization procedure. In one embodiment, a user may initiate the system 200 by launching an application on a smart phone or computer, which may, in preferred embodiments, prompt a participant (often an attorney) to input (or select an existing) case or case caption, participant contact information, email addresses, etc. Audio translation engine 207 may prompt each participant (deponent and attorneys) to introduce themselves or identify themselves (if they've used the system before and have an existing profile). Audio translation engine 207 will then, utilizing any means (voice, microphone assigned and proximate to or attached to a speaker, etc.) identify each individual so that it can property identify individuals and assign speech text to that individual, as opposed to other speakers. Audio translation engine 207 may then prompt the participants to administer an oath or otherwise prompt an individual to electronically or verbally attest (using, for example, an e-signature or, by giving verbal assent) to a pre-drafted oath. In some embodiments, the system is configured to recite an oath using audio output device such as a speaker device, and the deponent is prompted to provide their verbal assent, which, along with the oath, is recorded and reflected in the transcript. Signatures may be given using a touch sensitive screen of a user interface 109, in one embodiment.

As the participants (e.g., attorneys and deponent) speak, the system, utilizing the apparatus and methods above, will detect speech acts of each speaker, record and/or translate them, and convert them into text. In a preferred embodiment, this may happen in real time, and can be corrected by a speaker in real time. For example, audio translation engine 207 (e.g., speech to text module 234) may translate speech captured by microphone(s) 105 in real time into text identified by user. Such real-time translated text may be displayed to the respective users via user interfaces 109. While the deposition is still proceeding, ALPA may provide users with the option to edit text to reflect what was said by a user, in the instance of errors.

In instances where multiple individuals speak at the same time, the ALPA may alert the parties and caution them about talking over one another. In some embodiments, however, it will be possible for the ALPA to parse out the disparate, contemporaneous speakers, and produce a transcript in any manner indicating that two speech acts were occurring at the same time or indicating there was overlap.

In one embodiment, and in embodiments where, for example, each speaker has their own microphone 105 (said microphone which may or may not be associated by the system with a known or discrete speaker) the ALPA will contemporaneously time-stamp or otherwise mark all incoming audio data from multiple audio sources, such that audio data obtained from one microphone and associated with one known speaker will be marked with a time stamp (or functional equivalent) at the same time that audio data from other microphones, which are associated with other speakers, are also timestamped. When the ALPA is fed data streams from multiple data sources (i.e., from different microphones), the system may identify what data was being generated at 3:15:03 PM from microphone 1 and ascertain and synchronize with what data (audio data) was being generated at 3:15:03 PM from microphones 2 and 3 and 4 (or others). The system 200 may then utilize those time stamps in order properly order the speech events, in any manner desired, in a system-generated transcript.

In an alternative embodiment, system 200 may synchronize multiple data sources by analyzing not a common time stamp (or equivalent) but by synchronizing disparate data files by identifying across them an audio input that is substantially similar across the files. For example, in the case of multiple audio files, with different time stamps or lengths or start and end times, where the system 200 is able to identify a sound (a door closing, a horn), or a noise with a unique or semi-unique data profile, and that sound occurs across multiple data files, the system 200 will be able to identify that point in both (or across several) recordings (or files), and then work backward and/or forwards to synchronize the remainder of the files, thus “zippering” those disparate files, and the speech events that occurred on them, together. Other methods of synchronizing multiple audio files may also be utilized without departing from the scope of this disclosure. In another embodiment, the system accesses stored and/or time-stamped audio and, utilizing a user interface, a user may replay for other participants a portion of recorded audio to, for example, accurately reiterate a question posed by an attorney or an answer provided by a witness. See FIG. 9.

Regardless of how it is accomplished (all audio from a deposition, in one embodiment) whether by being captured in a single file, or by capturing and synchronizing multiple files, acquired across multiple audio detection devices (e.g., microphones), once these files are obtained, the system 200 may utilize them to create a transcript that accurately captures and orders speech event into a transcript, which in preferred embodiments is rendered by attributing speech events to an identified speaker. Once a deposition is complete, a participant (often an attorney) will utilize the system 200 to indicate that the deposition has concluded (e.g., via user interface 109). System 200 may forward a rough or complete transcript, or a notification that a transcript is available through a user interface, to all authorized parties requesting one (e.g., via e-mail). Where all processing is handled contemporaneously with the deposition, and there is an acceptable error rate, a transcript may follow immediately upon conclusion of the deposition. In some instances, additional processing may be required, especially where words are difficult to translate (proper names of people or places, foreign words, highly technical terminology that isn't readily translated). System 200 may present, via user interface 109, a list of terms to each speaker to clarify which term was intended. To ensure that no inappropriate or inaccurate post-deposition changes are made to the transcript, in some embodiments, system 200 preserves an audio recording of the deposition and a time stamp applied to both the audio recording and a time stamp to the translation, so there is no doubt of what was said if there is a difference of opinion among the participants.

In another embodiment, where the system is unable to identify a word from a data file (due to ambient noise, a plane flying overhead, etc.), or where the identification is tentative (below a pre-set confidence threshold for the translation), then the system 200 may automatically and proactively forward that data file or a portion of that data file to the speaker or to any other individual associated with that speech act, and that individual may listen to the original audio file and identify what it was they said. In another embodiment, where the original speaker is not available (or where otherwise desired) a human non-speaker translator may listen to the audio file and identify the words used. In some embodiments, system may pull out of a larger audio file a smaller audio file or a series of snippets from a deposition and forwarded in compressed or uncompressed and encrypted or unencrypted format to a translator, who can eliminate errors and verify the accuracy of the translation. In some embodiments, overseas translators may be utilized. In one embodiment, system 200 gives the participants themselves an amount of time to read and sign the transcript. Once signed, system 200 sends initialized transcripts to each of the parties and stored locally or in a cloud environment.

In one embodiment, the system 200 uses finished transcripts to increase accuracy of future depositions, especially where participants use the system in another deposition involving the same matter, wherein the same specialized language is utilized.

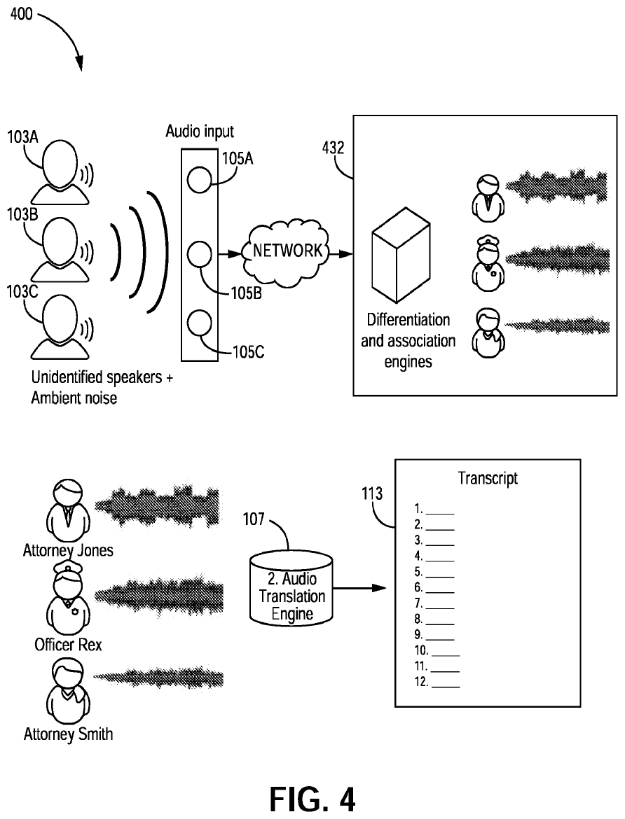

FIG. 4 is a conceptual diagram illustrating one example of an Automated Legal Proceeding Assistant (ALPA) system 400 consistent with one or more aspects of this disclosure. As shown in FIG. 4, system 400 is arranged to assist with a deposition with three participants 103A-103C. According to this example, each deponent is associated with a respective microphone 105A-105C. As shown in FIG. 4, digital data representing recorded audio from the deposition proceeding is communicated over a network such as the internet to a speaker identification module 432. The speaker identification module 432 comprises software instructions stored in a tangible medium executable by a processor of a computing device, such as user interface(s) local to the deposition proceeding, or one or more remote server computing devices located remotely from the deposition proceeding and connected via a network such as the internet. As shown in FIG. 4, speaker identification module 432 includes a differentiation and association engine 433 that maps recorded audio to one or more profiles associated with participants to the deposition. In this manner, the speaker identification module 432 assigns an identity to words and phrases included in the audio recording.

The assignment of an identity to recorded speech may be used, as also shown in FIG. 4, by audio translation engine 207 to generate a transcript 113 which reflects what was said by whom in the deposition.

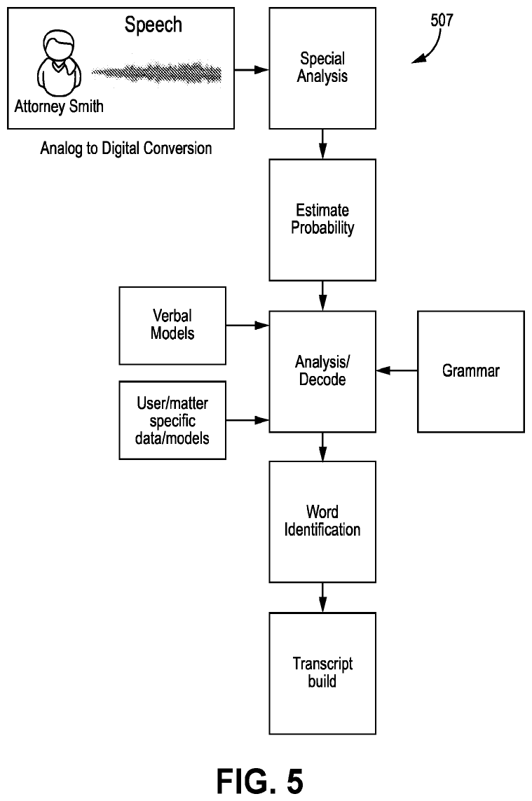

FIG. 5 is a block diagram illustrating one example of an audio translation engine 207 consistent with one or more aspects of this disclosure. As depicted in FIG. 5, audio translation engine 507 is configured to receive a digital representation of an audio recording that includes speech captured by microphone(s) 105 as part of a deposition proceeding. As shown in FIG. 5, audio translation engine 207 performs a spectral analysis on the audio recording. As also shown in FIG. 5, audio translation engine 507 estimates a probability that the performed spectral analysis is correct. As also shown in FIG. 5, audio translation engine 507 performs analysis on the audio data, to compare it to verbal models, user specific profiles, and grammar models. As also shown in FIG. 5, based on the comparison, audio translation engine 507 identifies words in the audio data. As also shown, audio translation engine 107 builds a transcript based on the identified words. This is but one example of the class of audio translation engines that may be employed. Any system known in the art or hereinafter developed may be employed without departing from the scope of the invention.

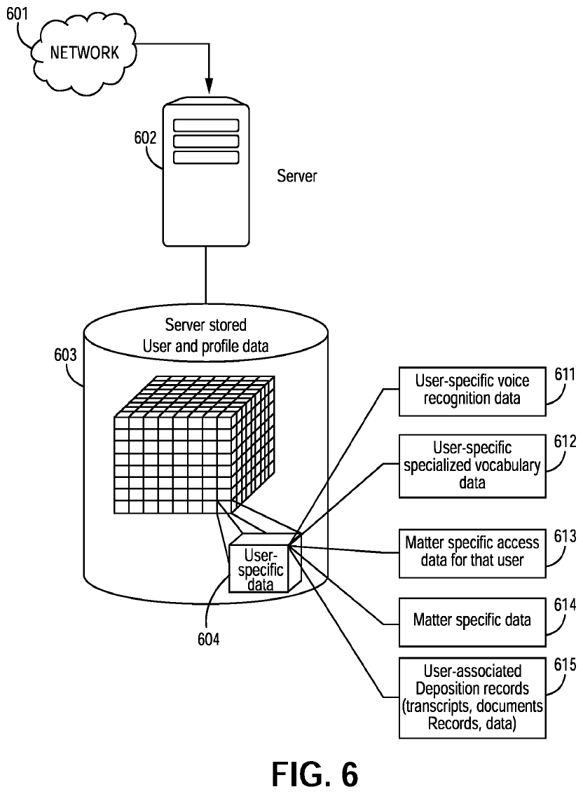

FIG. 6 is a conceptual diagram that illustrates one example of data that may be stored at a server computing device of an ALPA system 200 consistent with one or more aspects of this disclosure. As shown in FIG. 6, server 602 is coupled to a network 601, such as the internet. As shown in FIG. 6, server 602 is coupled to or contains one or more storage devices 603, for example temporary memory such as random-access memory, or long-term storage such as a magnetic hard disc, flash memory, or the like. Server 602 is configured to store user-specific data 604. As shown in FIG. 6, the user-specific data 604 may include user-specific voice recognition data 611, user-specific specialized vocabulary data 612, matter specific access data for a user 613, matter specific data 614, and user-associated deposition records 615. User-specific voice recognition data 611 may include one or more user speech profiles including speech parameters and characteristics that speaker identification module 232 uses to identify a speaker associated with a recorded audio segment. User specialized vocabulary data 612 may include data indicating specific vocabulary used by a particular deposition participant user, which may be used by speaker identification module 232, speech to text module 234, or both. Matter specific data 614 may include data specific to a particular court or law firm matter associated with a particular deposition or plurality of deposition proceedings. By way of example, said matter specific data may include data obtained from discovery documents associated with a specific matter (i.e., a specific litigation case), such as unusual terminology or names that occur in produced documents). User-associated deposition records 615 may include information associated with a particular user, which may include information from multiple deposition proceedings across multiple cases or matters that involved a particular user.

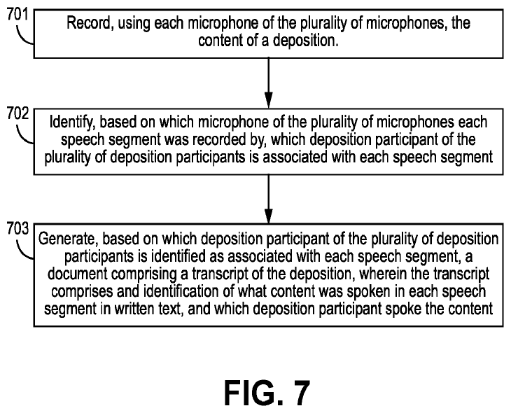

FIG. 7 is a flow diagram illustrating one example of a method of automatically generating a legal proceeding transcript according to one or more aspects of this disclosure. At 701, the method includes recording, using a plurality of microphones each associated with a deposition participant of a plurality of deposition participants, the content of a deposition. The content of the deposition includes a plurality of speech segments recorded by the plurality of microphones. At 702, the method includes identifying, based on which microphone of the plurality of microphones each speech segment was recorded by, which deposition participant of the plurality of deposition participants is associated with each speech segment. In other examples not depicted in FIG. 7, the method may include identifying which deposition of the plurality of deposition participants is associated with each speech segment based on processing the recorded audio segments to compare speech properties to a predetermined profile representing the respective deposition participants. The method may further includes converting the speech content of each recorded speech segment into written text. At 703, the method includes generating, based on which deposition participant of the plurality of deposition participants is identified as associated with each speech segment, a document comprising a transcript of the deposition, wherein the transcript comprises written text identifying sequentially what content was spoken and which deposition participant of the plurality of deposition participants spoke the content.

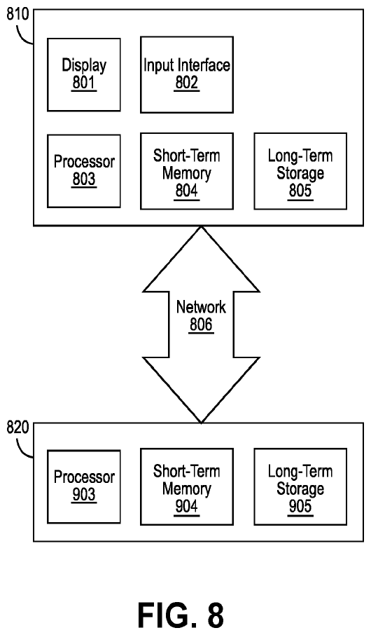

FIG. 8 is a block diagram depicting generally a computing environment in which the ALPA system 200 described herein may operate. As shown in FIG. 8, the computing environment includes both a local computing device 810 and a network computing device 820. Local computing device 810 is a device located close to a legal proceeding such as a deposition, and may comprise a desktop, laptop, smartphone, or tablet computing device. Local computing device 810 may serve as a user interface 209, which allows one or more users of ALPA system 200 to interact with system 200, for example to receive messages, or to input instructions or information, either before or during or after a deposition. For example, as shown in FIG. 8, local computing device includes a display 801 and an input interface 802. In the case where local computing device 810 comprises a laptop or desktop computer, input interface 802 may be a keyboard, mouse, trackpad, or the like. In cases where local computing device 810 is a smartphone or tablet computing device, input interface 802 may include a touchscreen display of the device configured to receive user input via touch.

As also shown in FIG. 8, local computing device 810 includes a processor 803, short-term memory 804, and long term storage 805. Processor 803 comprises any computing device, such as a central processing unit (CPU), graphics processing unit (GPU), Application Specific Integrated Circuit (ASIC), field programmable gate array (FPGA) or the like capable of executing instructions to cause local computing device 820 to operate in an intended manner. Long term storage 805 may comprise a tangible computer-readable medium configured to store data and program instructions capable of execution by processor 803. For example, long-term storage 805 may include one or more tangible media, such as a magnetic hard drive or flash memory hard drive. Short term storage 804, which is also considered tangible media, is configured to temporarily store instructions and/or data for execution by processor 803.

In operation, program instructions stored in long-term storage 805 may be loaded into short term memory 804, and executed via processor 803.

As shown in FIG. 8, the computing environment further includes remote computing device 820, which like local computing device 810, includes a processor 903, short term memory 904, and long-term memory 905. Each of these components operates similarly to their counterparts in local computing device 810, with long term storage 905 storing program instructions and/or data, which may be loaded onto short-term storage 904 for execution by processor 903. Remote computing device 820 may be communicatively coupled to local computing device 810 via a network, such as the internet.

One of skill in the art will readily understand that any portion of the ALPA system 200 described herein may comprise program instructions executable by a processor of either local computing device 810 (processor 803) or remote computing device 820 (processor 903). For example, any components of audio processing engine 207, including audio storage module 230, speaker identification module 232, speech-to-text module 234, and transcript generator 240 may comprise program instructions stored in respective tangible media (804, 904) and executed solely by local computing device 810 or remote computing device 820, or in combination between local computing device 810 and remote computing device 820 without departing from the scope of this disclosure. Furthermore, data used by system 200 to automatically generate legal proceeding transcripts may operate on data stored at local computing device 810, remote computing device 820, or both. For example, the various data depicted in FIG. 6, including user profiles enabling the identification of the source of recorded speech, may be stored in local computing device 810, remote computing device 820, or any combination of local computing device 810 and remote computing device 820.

As one specific example, during a deposition proceeding, each participant to the deposition proceeding may have access to a local computing device 810 (user interface 109) that includes instructions stored in short-term memory 804 or long-term memory 805 to cause a software application to execute on processor 803. The software application may serve as an interface for the respective deposition participants to interact with system 200. The software application may, for example, provide users with selectable prompts such as to initialize a deposition proceeding, to submit oaths, to assign microphones 105 to deposition participants, to commence a deposition proceeding, or to conclude the deposition proceeding, as examples.

According to this example, local computing device(s) 810 may be coupled to one or more microphone(s) 105, which may be either included in the respective local computing device(s) 810, or communicatively coupled to the respective local computing device(s). The software application may receive one or more digital representations of recorded audio data as one or more audio segments. The software application may send the recorded audio to data to remote computing device 820 via network 806. According to this example, audio storage module 230 may execute on processor 803 of local computing device 810 to prepare and send the audio data to remote computing device 820. For example, audio storage module 230 executing on local computing device 810 may encode audio data to reduce a transmission size of the audio data. As another example, audio storage module 230 executing on local computing device 810 may encrypt received audio data to improve a security of transmission of the audio data. At least a portion of audio storage module 230 may include software instructions stored in a tangible medium (short-term memory 904, long-term storage 905) of remote computing device 820, and may be operable to receive transmitted audio data and store it (e.g., in short-term memory 904, long-term storage 905) for processing.

According to this example, speaker identification module 232 and speech-to-text module 234 may include executable program instructions stored in a tangible medium (short-term memory 904, long-term storage 905) and executable on a processor 903 of remote computing device 820 that cause remote computing device 820 to associate respective deposition participants with speech contained in the stored audio recordings, and speech-to-text module 234 may process the stored audio to convert recorded speech into representative text. According to this example, transcript generator 240 also includes program instructions stored in a tangible medium (short-term memory 904, long-term storage 905) and executable on a processor 903 of remote computing device 820 that cause remote computing device 820 to generate a document comprising a transcript that represents sequentially what was said during the deposition proceeding, and who said it.

In an example, once an initial transcript is generated, transcript generator 240 executing on remote device 820 sends the generated transcript document, or a message alerting them to its availability, to one or more deposition participants via network 806. For example, remote device 820 may send the generated transcript, or notice of its availability, to the respective participants through the previously described software application executing on local computing device 810. As previously described, the generated transcript may include identifications of one or more ambiguities in the transcript that could not be resolved with a high probability of accuracy. In some examples, the software application may give the deposition participants a time-window in which to respond to accept, reject, or provide feedback with respect to the generate transcript, including identified ambiguitie(s). In some examples, once all deposition participants have responded to either clarify all identified ambiguities (see errata sheet information, infra) or accept the initial transcript, the software application executing on local computing device 810 may send an indication to generate a final transcript to the remote computing device 820. Remote computing device 820 may generate the final transcript, including resolving identified ambiguities based on deposition participant feedback received through the software application, and generate a final deposition transcript. The final deposition transcript may be sent to the participants via network 806 through the software application executing on the local computing device 810.

### Identification of Electronically-Stored Documents That are Related to the Selected Portion of a Transcript.

In an embodiment a speaker (for example a witness in a deposition) speaks and that speech is transformed into text by any means known in the art. In some instances, court reporter provides a “Realtime” transcript to an attorney which is a “rough” transcript of what was said by the speaker (e.g. a witness). In another instance, a Speech-to-text program (running locally or remotely) converts speech to text and displays that text using a computer (laptop, iPad, smart phone) or any other means known in the art. In one embodiment, the system uses content (text) from a transcript of speech, said content is utilized to search for and identify potentially relevant information (including, without limitation, data and documents, however comprised and wherever stored electronically, whether locally or remotely, including in cloud or non-cloud based environments), wherein such data is accessible via electronic means. Such information, data and documents can be located in eDiscovery databases, or in collections of literature such as scientific and peer-reviewed literature, or in collections of data, collections of information or collections of documents accessible via electronic means. Examples of such electronic databases include (by means of example and not of limitation): IEEE Xplore, Scopus, Web of Science, PubMed (biological and medicine references); ScienceDirect; Directory of Open Access Journals (DOAJ); JSTOR; or others. The information, data and documents can be of any format capable of being searched electronically and it may be maintained and accessed electronically in any manner known in the art or hereinafter developed without departing from the scope of the invention.

By way of example, and by using content from a transcript (a word, phrase, sentence, paragraph or the whole document itself) as input into a search protocol for identifying documents that are related to the highlighted text in some way.

The search can be conducted using any means known in the art related to text based searching, including using search methods utilized by eDiscovery software providers (e.g., Relativity, Everlaw, Logikcull, DISCO, Exterro, Sightline, ZDiscovery, Nextpoint, ZyLAB ONE eDiscovery, CloudNine LAW or Zapproved). Such methods include keyword searches. Such methods may include Boolean, Proximity, Stemming, Fielded, Semantic, conceptual or Fuzzy logic type searches, and metadata.

The data being searched can include data and documents stored in the cloud (including but not limited to information stored in public, private and hybrid cloud-based servers).

With reference to FIG. 19, an exemplary embodiment is illustrated in electronically stored documents are searched based on text selected from the real-time transcript. In this example, one or more participants 1900 produce audio data that is captured by microphone 1902 and provided to local system (ALPA) 1904. In this embodiment, the speech-to-text module 1908 utilized to convert the captured audio segments to text is located in the cloud (i.e., remote from the local system 1904), wherein captured audio segments are communicated via network 1910 to STT module 1908. In some embodiments, the communication of audio segments via a network requires breaking the audio segments up into a plurality of packets. The packets may be fixed or variable in length. In some embodiments, to avoid breaks in packets occurring mid-word, variable length packets may be utilized. In some embodiments, ALPA 1904 analyzes the audio segments received from microphone 1902 to detect pauses or breaks in speech, wherein the pauses or breaks are utilized as breaks in the audio segments.

In some embodiments, STT module 1908 generates a real-time transcript that is communicated to local system 1904 for display. In some embodiments, the real-time transcript is may also be communicated to an authorized remote system 1906 for display. Based on the real-time transcript, a user associated with local system 1904 and/or a user associated with remote system 1906 may generate search queries for provision to one or more databases 1912. As discussed above, in some embodiments the search query may be comprised of a single word, a plurality of words, an entire sentence, paragraph, or the entire transcript. In some embodiments, a user (either at remote system 1906 and/or local system 1904 may identify one or more databases to be searched based on the selected search terms. For example, in the embodiment shown in FIG. 19 a plurality of databases are available for searching, including an eDiscovery database associated with the particular proceeding, eDiscovery databases associated with other cases, a database of scientific literature, a database of deposition, and/or other databases. Search results may be communicated from databases 1912 to local system 1904 and/or to remote system 1906. In some embodiments, if the search/query originated with remote system 1906, then search results are returned to remote system 1906 (likewise for search queries originating with local system 1904). In some embodiments, search results returned to either remote system 1906 and/or local system 1904 may be shared with one another via network 1910. For example, search results provided to remote system 1906—if relevant—may be communicated or shared to local system 1904.

### Transcript Generation

In some embodiments, a transcript of speech is utilized as a source of input into one of more searches of electronically-stored state. In some embodiments, the transcript is produced in “real time” or “near real time” meaning that there is only a slight delay between a participant, such as a deponent, speaking and the creation of a transcript of that deponent's speech. The transcript itself can be rough or cleaned to remove errors.

In one embodiment, the transcript is created utilizing a “Realtime” Court Reporter that utilizes a computerized transcription system that translates the stenographic markings and which links, using a wired or wireless connection, to laptop or other device configured to display the transcript of the speech shortly thereafter (ergo, “real time”).

Essentially, as a court reporter (for example) types, the rough transcript shows up automatically on the attorney's laptop. Where desired, the system may also display the real time transcript on additional computers configured for that purpose, including computers remote from the location where the deposition is taking place. For example, in the context of a deposition where the court reporter, deponent, a defending attorney and an attorney administering the questions are present in the same room, as is typical, the realtime transcript may be displayed on the laptop accessible to the attorney taking the deposition, and it may also be displayed to a second attorney, using any electronic means, that is in a remote location, such as a second associate at a law firm remote from the location of the deposition.

With reference to FIGS. 20A and 20B, an exemplary embodiment is illustrated in which a court reporter is utilized in conjunction with a real time transcription system 2004 to generate real time transcript. In some embodiments, the real time transcription system 2004 utilizes a stenographic machine 2020 (shown in FIG. 20B) to aid in generating the real-time transcription. In some embodiments, the stenographic machine 2020 may operate automatically to convert audio captured by microphone 2002 to a stenographic transcript (i.e., comprised of stenographic symbols). In this example, the stenographic machine 2020 may include one or more dictionaries 2022 of terms utilized to aid in converting audio data to transcribed stenographic symbols. In other embodiments, stenographer machine 422 may be operated by a court reporter or stenographer that generates the stenographic transcription in real-time. The stenographic transcription (comprised of stenographic symbols) is provided to stenographic transcription computer 2024. In some embodiments, stenographic transcription computer 2024 is located locally. In other embodiments, stenographic transcription computer 2024 may be located remotely, wherein the stenographic transcription is communicated via one or more networks to the stenographic transcription computer 2024.

In some embodiments, stenographic transcription computer 2024 is implemented on a computer that operates/executes CAT software module 2026 and one or more dictionaries 2028. CAT software module 2026 reads the stenographic symbols and utilizes the one or more dictionaries 2028 to convert the stenographic symbols into text to provide a real-time transcript for display via local system 2010 and/or remote system 2008. In some embodiments, the one or more dictionaries 2028 utilized by the stenographic transcription computer 2024 are related to the one or more dictionaries 2022 utilized by the stenographic machine 2020. In some embodiments, updates or changes made to the one or more dictionary 2022 are communicated to the stenographic transcription computer 2024 for updating of the one or more dictionaries 2028.

As described in previous embodiments, the real-time transcript provided by real-time transcription system 2004 is communicated to one or both of local system 2010 and/or remote system 2008 for display. In addition, the real-time transcript may be utilized to generate search queries provided to one or more databases 2016a, 2016b (e.g., e-Discovery databases). Search results (e.g., documents, emails, etc.) are generated in response to the received search queries and are provided to one or both of local system 2010 and/or remote system 2008 for display. In some embodiments, local system 2010 is also in communication (via network 2006) with remote system 2008. In some embodiments, one or more users at remote system 2008 may generate search queries based on review of the real-time transcript and receive search results from the one or more databases 2016a, 2016b. In response, the search results or select portions of the search results are communicated from the remote system 2008 to the local system 2010. In this way, documents highly relevant to the deposition proceeding may be provided to the attorney and/or attorneys conducting the deposition in real-time.

As discussed above, in other embodiments the transcript is still generated in “real time” or “near real time,” but without the help of a court reporter. In one embodiment, the system is configured such that speech is captured by one or more microphones. Data representing that speech is generated and analyzed and is converted into text using “Speech-to-Text” (STT) technologies. The conversion of speech to text can be performed using a computing device configured for that purpose (such as a laptop), such that the conversion occurs locally, on the configured computing device, without the need to remotely access via networked means (e.g., via a wired or wireless connection) a second computing device configured with STT capabilities or similar service.

In another embodiment, data corresponding to speech is transmitted via networked means to a remote location where the STT conversion is completed or substantially completed and the resulting text sent via networked means to one or more individuals (including an attorney asking questions of the witness. Regardless if the means employed (via a live court reporter or via STT technology) the result is the generation of a transcript via any means of the speech, which in preferred embodiments is displayed electronically for one or more individuals.

Note that with the use of STT technology, we essentially duplicate the functionality of the “Realtime” court reporter by creating our own “rough” transcript using real time speech to text. The result is the same—a running transcript will be created on the attorney's laptop.

Referring now to FIG. 15, a representation of a “real time transcript” which is displayed on a computer (e.g., the local system and/or the remote system). The “Real Time Transcript” may be generated, as discussed supra, by a court reporter or transcriptionist, or it may be generated by any other means, such as a STT engine running locally on the computer or running remotely and transmitted back to this computer. In some embodiments, the Real Time text would scroll as additional material is added during the deposition (either as created by the STT AI or by the link to the court reporter's transcription system. In the embodiment shown in FIG. 15, the display interface includes a real time transcript window 1500, tools window 1502, search tools window 1504, deposition window 1506, indexed search results window 1508, document preview window 1510, and document display window 1512. In some embodiments, real time transcript window 1500 displays the transcript in real time. In response to additional speaking by participants, the transcript is generated in real time within the window, with new text added to the top or bottom of the window. In some embodiments, tools window 1502 provides tools to allow a participant to control one or more aspects of the deposition process. In the embodiment shown in FIG. 15, the tools include a ‘Pause Transcript’ button, an ‘Auto-Identify key terms’ button, and a ‘Highlight text for search’ button. The ‘Pause Transcript’ button pauses recording and/or transcribing of text, essentially taking the deposition off-the-record for a period of time. The ‘Auto-identify key terms’ button, when selected, results in search queries being generated/communicated to the one or more databases in response to particular key terms being found in the real-time transcription. For example, a user may identify a number of key terms prior to the deposition, wherein in response to a deposition participant (or particular deposition participant) saying the word, an automatic search query is generated and results displayed to the user via indexed search results window 1508 and/or document display window 1512. In this way, a user may not be required to highlight key terms and/or generate queries during the deposition, rather, pre-selected words may initiate automatic search queries without requiring user input. The ‘Highlight text for search’ button, when selected, collects text highlighted by the user from the real-time transcript window and provides the selected text as a search/query to the one or more databases. That is, the ‘Highlight text for search’ allows for a user to manually select terms to search based on the real-time transcript displayed to the user.

In addition to the tools window 1502, the search tools window 1504 allows a user to manually enter search terms and/or import search terms using the ‘highlight text for search’ button. In addition, the tools window 1502 allows for different types of searches to be selected, including keyword search, semantic similarity search, and/or concept search. A keyword search may be utilized to look for the keyword appearing in the document. Semantic similarity search is not confined to the specific terms provided; rather, semantic similarity search allows the search to be expanded to include terms that are similar to the terms provided. The ‘link database’ button, if clicked, allows the user to select/modify the databases to be search. The ‘weight returns’ button allows the user to select/modify the relevance of documents presented to the user. For example, the button ‘doc types’ allows the user to select the type of documents to be returned (e.g., Word documents, Excel documents, emails, etc.). Likewise, the ‘individuals’ button allows the user to identify individuals (e.g., authors) whose authorship should be prioritized.

### Auto-Identifying Pre-Determined Terms in the Realtime Transcript

In one embodiment, selecting the button ‘Auto-identify key terms’ results in the system is configured to identify in real or near real time the presence of certain kinds of content in the STT transcript, such as the utterance and recognition of an important term or phrase, wherein the phrase may be important in a trial. Upon the identification of the presence of a key term or phrase, or its equivalent, the system is configured execute a search, e.g., via a search protocol, for content related to that key term. the deposition, the system had a list of “key words” or “hot terms” that were important to the case. When the realtime transcript indicates that one of those key words was spoken, then the system is configured to recognize that fact and then utilize that term or transcript content as part of a search for identifying electronically stored content, such as relevant documents in the discovery database.

### Designation of Text to Utilize.

In another embodiment, an individual (such as an attorney) may utilize a user interface to identify or choose portions of transcript for the purposes of utilizing the same for generating a search or as input into a search of electronic data. FIG. 15A (C).

In one embodiment, if the deponent says something interesting and the attorney wants to find documents related to what was just said, then we permit the attorney to highlight (or otherwise designate) a word or a phrase of a section of the transcript using the ‘Highlight text for search’ button located in the tools window 1522. The designated portion of the transcript is then utilized to as input into one or more searches of electronically stored data (e.g., eDiscovery databases, search engines, scientific journals, etc.).

In another embodiment the system is configured to permit a person (e.g., an attorney) to type in their own text or utilize other text or content as part of a search via the search tools window 1524.

### Electronically Stored Content (Any Content; Any Means of Accessible, Electronic Storage).

In one embodiment, the system is configured to use content from a transcript as input for conducting searches for related documents, data and information stored electronically (whether locally or remotely). By way of example, and not of limitation, depicts a computer configured to access an eDiscovery database, such as those offered by Relativity (pictured here) or other eDiscovery tools and services, such as Everlaw, Logikcull, DISCO, Exterro, Sightline, ZDiscovery, Nextpoint, ZyLAB ONE eDiscovery, CloudNine LAW, or Zapproved (as examples). The use of content from a transcript may be utilized in conjunction with search tools utilized by eDiscovery tools, such as Relatively. By way of example, Relativity was developed to help attorneys manage large sets of documents, review those documents, code those documents as being relevant in various ways to the case (relevant to damages or relevant to liability, or relevant to some aspect of the case). Relativity comes equipped with many ways to search through that data. Boolean, key word, semantic and concept based searches, among others. etc. Concept searches enable teams to put in a chunk of text (e.g., where an attorney utilizes a section of text from a transcript—even a paragraph or more—to search for documents that are conceptually similar to that block of text. The documents returned are sorted by how closely they match the text conceptually. The benefit is that you'll find documents discussing the same topic, even if they don't use the same words to describe it. The system can be configured to utilize any and all search capabilities offered by services, such as Relativity, to search for and identify data and documents, including metadata.

In some embodiments, the system is configured to identify some portion of a electronic data depository (such as a Relativity database) and copy and/or export that portion of the database for searching. This is useful where a user is utilizing the system but does not have a wired or wireless connection to access remote data. In such a case, potentially useful data may be obtained in advance. For example, in the context of an e-discovery database, that portion of the database containing documents specifically related to a witness (identified via metadata or other data indicative of its relativity) may be proactively identifies and exported. Such a database can be limited to documents from a particular date range, or file type, or any other limitation used by those in the art. Additionally, the system can be configured to augment, expand and/or combine accessed outside databases, for example by augmenting them with collections of depositions transcripts. Such augmentation permits an attorney to compare what a witness says in real time with a plurality of other depositions to identify, for example, similarities, differences and contradictions.

As discussed above, indexed search results are shown in indexed search results window 1508, which illustrates a list of documents that are identified from the larger database that match the search parameters. Document previews may be shown in the document preview window 1510 such that you can scroll down each of the documents (in an embodiment, each has its own unique alphanumeric code) and it will give you a preview of what that doc looks like without having to open it. If you do open it, then the document is displayed in document window 1512 such that a user can read the document itself in various formats. In some embodiments, search terms utilized to locate the document are highlighted for the user to allow relevant portions of the document to be easily identified by the user.

A wide variety of search tools exist within eDiscovery and other electronic repositories of data and documents. The system can be configured to utilize all of them. Additionally, in some embodiments, where data is stored electronically (e.g. in a database) and the database is not configured to permit complex searching (e.g., contextual, symantic or fuzzy logic searches), then the system may be configured to extract the data in that system, using any means known in the art, and load it into a system containing augmented capabilities and process that data in order to facilitate searching.

In some embodiment the system may also be configured to use content from a transcript as an input for conducting searches for related documents electronically in other sources of data, information and documents, such as public or proprietary databases of scientific journals academic journals, institutional repositories, archives, or other collections. See. E.g., e.g., https://en.wikipedia.org/wiki/List_of_academic_databases_and_search_engines.

In one embodiment, the system can be similarly utilized for searching via third party search engines.

### Exhibit Creation and Export

Once a transcript is generated and a portion of that transcript is utilized as input into a search for electronically stored data and information that is relevant in some manner to that text, where a document is identified as part of that search, then the system may be configured to identify that document as an exhibit. In one embodiment, the system is configured to print the document or export the document to one or more recipients or display the document. In one embodiment, the system is configured to emboss the document or data with an exhibit sticker.

### Notice and Stipulation Module

In one embodiment, the system incorporates a Notice and Stipulation Module (NSM), which can be utilized to generate and forward on to one or more parties (e.g., a deponent and/or an attorney) a document in the form of a notice, stipulation, agreement or similar)(“Notice”) providing to one or more parties at least some subset of the following information:

Notices may include a Notice that an oath (of the kind typically administered in advance of the taking of sworn testimony) will be administered via sworn declaration or affidavit or similar; a Notice that that it would be administered by a notary public who is an employee of one of the attorneys, or as otherwise agreed by the parties; a Notice that the deposition will not be taken in front of an officer, or other third-party, or an in-room court reporter, but will rather be recorded by electronic means and forwarded to a remote transcriptionist or court reporter, or, alternatively, to a non-human or AI-enabled transcription service or module; a Notice that the deposition will be recorded and that the recording will be available to both parties in real-time (or shortly after the deposition); a Notice that the deposition will be recorded and a transcript created using computer-assisted recording and transcription means; a Notice that the testifying witness will be provided the opportunity to “read and sign” the transcript with any corrections as provided for in the Rules; and an agreement or notice that once this is done, the computer-assisted methodology will generate a transcript that will constitute the “certified” transcript; a Notice that the parties agree that the authenticity of the testimony shall not be challenged with respect to certain matters (e.g. on the basis of who administered the oath, swore in the witness, or transcribed the testimony, who constitutes an officer for the purposes of assisting in the deposition, and the like); a Notice that if any court in the trial of this matter or on appeal deems the deposition transcript defective due to any issue of compliance with the rules of civil procedure or the rules of evidence governing the taking of deposition testimony or the use of such testimony at trial or for any other purpose, the Parties agree that the deposition shall instead be an “interview in lieu” of a deposition and that the testimony shall nevertheless be admissible;

The Notice and Stipulation Module is, in some embodiments, accessed via computer means via a user interface. Using the NSM, a user, generally an attorney, paralegal, administrative assistant, can initiate the creation of a new Notice, as set forth above. Using the NSM, the User can designate a court or jurisdiction applicable to a legal matter. The NSM stores locally (or accesses remotely) one of a plurality of templates each of which corresponds to and/or complies with the form and rules of the applicable jurisdiction. The NSM is, in preferred embodiments, automatically notified of changes to the applicable rules of a court or jurisdiction.

In one embodiment, the NSM is linked with printing means for printing the providing the completed Notice such that it can be mailed, delivered or served to one or more recipients. In another embodiment, the NSM is configured to render the Notice as a PDF document (or other file type), and is delivered to one or more recipients via electronic means. In another embodiment, the system is configured to enable the recipient of a Notice (or its/their representative) to indicate via a user interface that they are waiving physical service of a Notice.

In some embodiments, the voice recognition and speech to text conversion occurs remotely from the location where a deposition or testimony is taking place, with the audio data sent via networked means (e.g. over the web). In another embodiment, the system performs the speech-to-text conversion locally and in some embodiments performs the voice recognition analysis locally, such that a transcript of the deposition is displayed on a user interface without the need to transfer audio data over the web or elsewhere via networked means, thus enabling the system to provide near real time transcription and voice recognition in the absence of reliable internet or network or hardline connection.

### Exhibit Management Module.

In one embodiment, the System is equipped with an Exhibit Management Module (EMM). In one embodiment, the EMM will contain storage or remote access means for accessing, displaying, manipulating and marking exhibits previously used in the instant case or in other cases available for use. By accessing the user interface, a deponent can select existing exhibits (stored either locally (e.g. on a laptop) or remotely), and, via a linked display device (e.g., an iPad, tablet or other monitor) display the same to a witness or deponent. In preferred embodiments, the display device will permit the witness to mark or make notations on the document, and where they do to, the marked document will be saved via memory means as a new file or document, complete with the deponent's alterations to that document, essentially creating a new exhibit or document distinct from the original exhibit. In another embodiment, where the system is configured to access a broader database of documents or files (that are not currently exhibits) the witness may also be presented with means for marking that document, and the system will be configured to dynamically mark that document to create a new exhibit.

For instances in which days where attorneys are dual tracking depositions (taking a deposition in two locations in the same day, using two attorneys at different locations) the system can be configured to assign them odd number exhibits for marking additional depositions and the other even numbered exhibits, so that depositions taking place on the same day will not create confusion by utilizing the same exhibit notations for different documents. Similarly, if three depositions (or more) are occurring in close temporal proximity, the system can be configured to assign each deposition team a unique set of numbers (or alpha numeric equivalent):
1,4,7,10,13
2,5,8,11,14
3,6,9,12,15

Any alphanumeric system can be used so long as it does not result in attorneys or participants in different depositions utilizing the same alphanumeric designations for different documents or exhibits.

In one embodiment, the EMM has access to documents in a remote document database and is configured with means to turn that document into a new exhibit, should you want to. In other embodiments the EMM has access to documents stored locally. In one embodiment, the System has the ability to take in newly-produced documents, for example, subpoena duces tecum documents brought in same day by a witness. If the documents are produced that day, the documents may be imaged using any means and imported into the System for same day use. The system is configured to enable the documents to be manipulated, marked with bates numbers, stored, marked as an exhibit, and sent to another participant.

### Video Module

In one embodiment the system is equipped with both microphone means for capturing the speech of a participant as well as video means for capturing a deponent or witness as they are testifying. In one embodiment, the system is configured to link the speech data with video data using any means know in the art or herein disclosed. In another embodiment, after the transcript is created during a deposition, a user may utilize the user interface to designate a portion of that transcript. The transcript portion so designated or selected by the user is linked to a portion of the audio and/or video file to which the transcript corresponds, enabling the corresponding audio and/or video to be played for the user. In another embodiment, a user may utilize the interface to identify for export (in the form of a file) a portion of audio or video. For example, where an attorney asks a question of a witness and the witness responds with information that may prove dispositive in a case, an attorney, using the interface, can select one or more sections of audio and/or video, utilize the system to create a snippet of the desired audio and/or video, and export the same to a team member, to a client, to the court or to opposing counsel (as examples).

Referring now to FIG. 11, in some embodiments, the ALPA system creates an errata sheet 1100 linked to the deposition transcript. In one embodiment, the system permits a deponent or an authorized individual to identify a portion of the text for potential amendment or correction or alteration and indicate the text in an errata sheet. In another embodiment, a user (e.g. a deponent) need only highlight or otherwise select a portion of the testimony and it will auto-populate an errata sheet, permitting a user to then designate a correction. In the example shown in FIG. 11, the errata sheet 1100 includes eight columns. Each row represents a potential error in the provided transcript. The first two columns (1102, 1104) identify the portion of the audio recording that contains the error (e.g., citation start time, citation end time. The third column 1106 identifies the transcript as originally transcribed. The fourth column 1108 identifies a suggested modification of the original transcription. The fifth column 1110 identifies the reason for the change as provided by the person making the change. The sixth and seventh columns 1112, 1114 allows the opposing side to indicate whether they agree or disagree with the change. The final column 1116 provides a link to an audio segment associated with the disputed transcript. In another embodiment, a user can push a virtual button in an interface, which with signal to the system to play back the audio or video from the deposition or legal proceeding that corresponds with the text, such that the User can determine whether or not the correction they wish to make is permissible.

### Remote Deposition Module.

In one embodiment, the System is configured to enable the participants to be remote from one another. As stated, infra, the system accommodates all users being remote from the witness, as well as having one or more users being in-room with a witness (or speaker) and one or more additional users of the system remote, but nevertheless able to utilize the system to do one or more of the following: use a module, receive transcription and/or audio of the witness or speaker, utilize transcribed speech to search databases, and communicate, among other activities.

### Remote Broadcast of Deposition in Real Time.

In one embodiment, the System is configured to permit someone in a remote location to listen into, watch, and comment privately to their colleague through a user interface on the testimony (through our portal) by, among other things, offering suggestions for cross, etc. In another embodiment, the user interface permits a second individual to identify, send or suggest additional documents to use in conjunction with questioning a witness, including documents identified using designated portions of the real-time speech to text transcript generated during the deposition, as expounded on herein. Especially using the functionality that is mentioned, above.

### Deposition Preparation

The systems set forth herein may also be used to assist individuals outside of a deposition, trial or other legal proceeding. For example, the real time speech to text capabilities set forth herein may be utilized by attorneys or others to help prepare a witness. The system may be used to generate a real-time transcript, and the terms or phrases identified as important by the system (because they are on a list of key terms (or similar), are identified and used to pull up related documents from a database, which the individual to be deposed may want to review in advance to, among other things, ensure that their memory of events is accurate, make sure that they are not contradicting documents they've authored previously (emails, memos, letters, etc.) and to discover whether their testimony on a specific topic is or is not consistent with other information, such as the deposition testimony of other individuals in the same case, related cases, or any other case, as examples.

### Post-Deposition Analysis

Similarly, the above systems may be utilized after a deposition or testimony has been concluded. For example, a user of the system may utilize it to access a particular deposition, highlight portions of it, and search for documents relevant to that testimony, which may prove useful for countering the testimony at trial or during motion practice.

### Defense

Similarly, the system may be utilized not to create an admissible transcript, but instead used by individuals defending a witness to identify in real time documents that can be used to cross examine a witness or rehabilitate a witness. For example, where an attorney is defending a witness and the deposing attorney cherry picks a document that purports to characterize the deponent's opinions on a subject (e.g. Punxsutawney Phil), the defending attorney can identify in real time a document which sheds more light on that topic, etc. They system has several uses independent of its use as a means for producing a transcript.

### Voice-Stress Mental State Analysis Module.

In one embodiment, the System is equipped with a voice-stress module or modules that analyze speech for data indicative of an emotional state, or sincerity or duplicity or stress (or any other emotional state). In particular, the System subjects the audio from one or more designated individuals and provides an alert, such as a visual alert on a user interface, when the analysis detects (for example) microtremors or registers stress (using stress as an example) utilizing various analytical techniques as are recognized by those skilled in the art, including (for example) an analysis of the mean energy, the mean intensity, MFC coefficients, the computation of the mean and the standard deviations, utilization of Neural Networks, etc.

In one embodiment, the user interface is configured to create a transcript where the testimony is annotated by a designation of the mental state corresponding to the voice-stress analysis (e.g., red denoting anger or stress; blue registering calm). Any designation can be utilized without departing from the scope of the invention. For people that are using the system, in an embodiment you may have (for internal use) an annotated version which indicates speech events that are characteristic of higher stress and/or deception or other mental states. By way of example, the module may be configured to detect stress and emotions using a variety of factors, among them: detect subtle changes, microtremors, etc. (see infra for other examples). The system can be configured to perform these analytics during the deposition or even after the deposition via, for example, a post deposition analysis of the associated audio file. Though, obviously, having it during the deposition is more valuable.

In one embodiment, the system is configured to identify in real time or near real time data from speech that is indicative of one or more mental or emotional states. Where , and identify the speech that corresponded to the data associated with that mental state. In one embodiment, the STT module (or Realtime transcription of that speech generated by a transcriptionist) is identified and utilized to conduct searches within one or more databases, including eDiscovery databases and/or outside databases (e.g., databases containing scientific works, news content, third party records, deposition transcripts).

### Realtime Cross Referencing to Related Depositions.

In one embodiment, for example where there is a strong correlation between what someone is saying in one deposition in real time with the testimony of someone else in the same case or in a related (or unrelated) matter, the system can identify the relevant or related portion of another transcript. In an embodiment, where a deposition is being taken of a witness in a matter that is related or potentially related to one or more other matters or litigation cases in which testimony has been taken (e.g., in the form of depositions) or expert reports and/or eDiscovery has been exchanged, the system may be configured such that a user may designated content in the displayed transcript and initiate a search process. In such a manner, related testimony stored in a connected eDiscovery database may be identified and scrutinized for, among other things, consistency. Where inconsistent with present day testimony, the user may (for example) utilize the contents of former depositions to question a current testifying witness on the record. By way of Example: You are deposing Ms. Smith. During her deposition, you can view privately, using the user interface, the related deposition testimony of a second individual (or earlier testimony of Ms. Smith), and ask craft a question for Ms. Smith which (perhaps without her knowledge) invites here to testify in a manner that is either consistent or inconsistent with prior testimony. Such questioning techniques may be utilized without informing the witness that you are referencing earlier related testimony and one may question the witness without telling them with whom they are agreeing or disagreeing.

### Localized Storage of a Subset of a Larger Discovery Database.

In one embodiment where a user of the system is taking a deposition in a location that makes it difficult to access a remote database of documents (e.g. an indexed discovery database such as Relativity) in real time, the system can be configured to locally store a subset of one or more larger databases for local searching. For example, discovery databases can be huge, containing millions of pages of documents. Where an attorney wishes to use the system in a location where there is no reliable internet or network connectivity, but that attorney nevertheless wants to use an embodiment of the system that enables the near-real time identification of relevant documents based on the real time speech of a deponent or witness, the system can be configured to store locally any subset of those document, the parameters of the subset being based on one or more factors, including, for example, all documents where metadata suggests that the deponent is an author; Documents where metadata indicates that the deponent was copied (e.g., the deponent didn't write an email, but was copied or BCC's on an email); documents that came from the possession of the deponent, or other documents or prior depositions deemed potentially important.

### Name Recognition Module

With reference to FIGS. 21 and 33, in some embodiments the ALPA system 200 provides automatic name recognition and prompts for clarification where parties share the same (partial) name. In one embodiment, at step 2100 the ALPA sends an initialization request to eDiscovery system. At step 2102, the eDiscovery system performs a search of documents related to the proceeding and identifies names (e.g., Joseph Simmons). At step 2104 the list of names is communicated to the ALPA system 200. At step 2106 the list of names are included as part of the name recognition module. At step 2108 the real time transcript is generated based on captured audio segments. At step 2110, the ALPA identifies names within the transcript that may refer to one or more names stored in the name recognition module (e.g., reference to ‘Joe’ may refer to one of four different Joes, Josephs, Joeys, etc. identified during the initialization process. Alternatively, the ALPA may be configured to recognize one or more proper names uttered and appearing in a transcript (step 3306) and upon such recognition initiate a process (see FIG. 33). In an embodiment, at step 2112, the ALPA prompts the user in real-time for clarification regarding which ‘Joe is being referred to. In some embodiments, the prompt may include a list of all possible Joes identified during the initialization stage. An example is provided in FIG. 14 in which the name detected by the name recognition module is ‘Joe’, but four possible candidates are identified, including ‘Joseph Simmons’, ‘Joe Vetter’, ‘Joey Bear’, and ‘Joseph McCarthy’. The user may follow up with clarifying questions, or may simply select the proper individual from the list provided.

In some embodiments, the name recognition module also allows for searches to be conducted regarding a selected name. For example, if in a previous deposition a deponent indicates that they participated in a meeting where Joseph Simmons was present. In some embodiments, instances of the name appearing in other depositions may be displayed. In some embodiments, this is performed as part of a normal search/query of a database, but may be initiated simply by clicking on the name of the identified person, rather than having to generate a search/query or through a different means.

In some embodiments, with respect to individuals it may be beneficial to search databases outside of those associated with a particular matter (i.e., eDiscovery databases). For example, it may be useful to conduct general internet searches, social media searches, etc. In some embodiments, a search of an individual's name may be focused on those documents authored by the individual, including emails, documents, etc. In other embodiments, it may be beneficial to conduct metadata or other searching of discovery database to determine who a particular person is most connected to (e.g., to whom does the person send the most emails, receive the most emails, etc.). Consider, for example, a typical PST file (i.e., the files associated with Microsoft outlook emails, which are typically captured as part of any e-discovery plan (Microsoft Personal Folders File (PST) Metadata). In addition to the default metadata set, you can extract Messaging Application Programming Interface (MAPI) properties from a PST file. These properties describe elements (subject, sender, recipient, and so on) of Outlook items within the PST file. Since the properties are stored in the PST file itself, they can be retrieved before the contents of the PST are extracted. For example, FIG. 22 illustrates a graphical representation of connections based on analysis of a PST file. In some embodiments, this analysis may be utilized to determine whether an Outlook item should be extracted based on a subfile's attributes. MAPI properties are also stored for Outlook attachments that are not mail messages (such as an attached Microsoft Word document or Lotus 1-2-3 file). In some embodiments, PST metadata may be analyzed to identify unique email senders and recipients.

As shown in FIGS. 22A and 22B, connections to a particular individual can be determined and displayed—either graphically or via a report. In some embodiments, larger bubbles represent frequency of contact or strength of relationship with this Joe, as objectively measured. In some embodiments, bubble colors may be utilized to indicate organization to which each individual belongs. In other embodiments, other ways of organizing and displaying the information may be utilized.

As shown in FIG. 22B, in some embodiments a user can then click on (or otherwise designate) an individual (e.g., ‘Sue’) and receive a list of documents that are related to both Sue and Joe. Additional parties may be added to further refine the search. In other embodiments, additional information regarding patterns of Joe's communications with other people related to a particular matter may be determined. For example, in one embodiment communication between Joe and another individual (e.g., ‘Kristen’) may be selected and viewed, as well as communications between Kristen and others.

### Ability to Take a Deposition But Not Pay to Create a Transcript.

Another benefit of the ALPA system is that if an attorney taking a deposition determines that the deposition was of no or little value, there is no requirement that the deposition must be transcribed. This is in contrast with a typical deposition, in which the court reporter is paid for in full prior to the deposition, and therefore there is no option to prevent a full transcript from being produced.

### Deposition Suggestion Module

In some embodiments, the ALPA may be capable of performing analysis on the real time transcript to provide suggestions to one or more parties. In an embodiment, suggestions include suggestions for an attorney to object to a question. In an embodiment, speech may be converted into text (FIG. 33, 3304), and the contents of that text are analyzed for the presence of speech indicative of objectionable content. For example, a deposition suggestion module may receive or monitors the transcription (as displayed on the user interface) and is configured to recognize the presence of terms that may give rise to an objection (e.g., leading question, etc.). For example, analysis of the real time transcript with respect to a term “You told Norman that you would never deliver the order on time, didn't you?” may be flagged as potentially leading because of the phrase “didn't you”. In response, the ALPA system may initiate a process, including in an embodiment the generation of a notification displayed on the user interface suggesting an objection to the question. Alternatively, it may also be used to identify for the attorney questioning a witness that their question is potentially objectionable and thus prompt them to state it in a non-leading form.

Additionally, near the conclusion of the deposition, and in one embodiment, the system may prompt the deposing attorney, via the user interface, to note additional things on the record. For example, the user interface can be utilized to prompt the deposing attorney to state, on the record, that they are reserving their right to conclude the deposition at a later date, or note that they are keeping the deposition open, or prompt participants to make stipulations in the record.

### Transcript Review Module

In some embodiments, embodiments the user interface can be configured to permit a user to designate a portion of the text of the transcript, which is linked to an auto and/or video file and, and upon designation, initiate the playing of the audio and/or video for review. This functionality may also be utilized in conjunction with the review of pending changes to an errata sheet, as stated herein. In another embodiment, the user interface may be used to highlight or otherwise designate a portion of the testimony, whereupon the system is prompted to create an audio or video file, which is then downloaded from the system or which the user may utilize the system to send the audio or video file electronically to one or more recipients, including via email.

### Augmented Libraries

In one embodiment, the system may be utilized to create specialized libraries of specialty terms. For example, in some embodiments libraries that are specific to the speech of a user of the service (i.e., a particular lawyer and their speech patterns). In other embodiments, a library may be created that is specific to a particular case, such as created, for example, by analyzing the pleadings, motion practice and discovery for key terms, as well as deposition transcripts from the past. In some embodiments, a library that is specific to a class of case types: (asbestos, mesothelioma, pharma, medical malpractice, med device, mass tort, generic personal injury. In some embodiments, libraries may be autoloaded for a user for use by the transcription module, where a user designates a case type. In some embodiments, a library that is specific to a client—of the client's business or literature uses specific terms or exists in a specific technology area, then any time a new case is handled for that client, the client library is loaded to assist the AI in performing speech to text translation.

### Analyzing Exhibits to Determine Key Search Terms

Referring now to FIG. 23, in some embodiments the ALPA system may be initialized to determine key words or phrases to be looking for during a deposition. For example, in the embodiment shown in FIG. 23, at step 2300 a first subset of documents is uploaded to the ALPA (i.e., local system). In general, these documents are selected as highly relevant to the proceedings or to the deposition in particular. In one embodiments, documents uploaded include exhibits to be utilized during the course of the deposition and/or proceedings. At step 2302, the first subset of documents are analyzed to determine key words or phrases. The determination of which phrases are relevant may be based on prior case experience. For example, in some cases documents may be analyzed based on prior case models For example, a patent litigation case may be analyzed to detect possible public disclosure of a patent that would invalidate a patent, wherein terms like “trade shows” or “presentation” in combination with or close to terms related to the invention may be added to a search list. At step 2304, the ALPA system generates and displays the real-time transcript. At step 2306, the ALPA compares key words/phrases identified at step 2302 to the real-time transcript to identify search terms/queries to be generated. For example, the term “public disclosure” was identified as relevant at step 2302, which is located in the real-time transcript. Key words may be selected based on people and/or events identified as associated with the term “public disclosure” and may be selected as search terms. At step 2308 the search terms are communicated to the eDiscovery system to initiate a query/search of the database based on the supplied terms. At step 2310, the eDiscovery system performs a search/query on the selected databases utilizing the search terms provided. At step 2312 the search results are organized/indexed, and at step 2314 the indexed search results are communicated to the local system for review. At step 2316 the indexed search results are displayed to a user via the user interface.

### Applying Training Data to Databases to Identify Sub-Set of Relevant Documents

Referring now to FIG. 24, an embodiment is provided in which training data is utilized to select a sub-set of documents from the eDiscovery Database. In some embodiments, these documents are identified as particularly relevant to the proceeding and/or deposition. Subsequent searches of the eDiscovery system are directed first to the identified sub-set of relevant documents.

At step 2400, the ALPA initializes the eDiscovery system. In some embodiments, this may include identifying the type of litigation (e.g., civil, criminal, personal injury, patent, etc.). In response, at step 2402, the eDiscovery system applies training data to data associated with the eDiscovery system to identify a first set of most relevant documents. For example, in divorce litigation the most relevant information may include financial statement, emails including discussion of accounts or dollar values, and/or other information related to financial accounting (as well as other types of documents). These documents are included in the first sub-set of documents identified as potentially more relevant than others.

At step 2404, the deposition proceeding begins and a real-time transcript is generated. At step 2406, search terms are selected (either automatically or manually) from the real-time transcript and at step 2408 the query/search terms are communicated to the eDiscovery system. At step 2410, the eDiscovery system performs a search of the first sub-set of documents identified at step 2402 based on the query/search terms provided. At step 2412, search results are organized and indexed, and at step 2414 the indexed search results are communicated to the ALPA. At step 2416 the results of the search conducted on the first sub-set of documents is displayed to the user. In some embodiments, the eDiscovery system may initiate searches both on the first sub-set of documents as well as the entire database. In some embodiments, indexed search results for both searches are generated, and may be provided to the user for display. That is, the user may review the indexed search results associated with the search conducted on the first sub-set of documents and if those search results do not include the desired information then the user may display and/or review the indexed search results conducted on the entire eDiscovery database (or selected databases). In this way, the ALPA is able to leverage knowledge from other proceedings in order to identify those documents most relevant to the current proceeding.

Referring now to FIG. 25, an exemplary screenshot is provided that illustrates the display to a user of the real-time transcript 2502, search/query window 2504, search results window 2506, and search results summary 2508. In some embodiments, the real-time transcript automatically updates as additional speech is converted to text. In some embodiments, the real-time transcript displays the speaker associated with converted text. Search/query window 2504 allows a user to enter search queries utilized to search the one or more databases. In some embodiments, the user can highlight words or strings of words from the real-time transcript, wherein the selected word or strings of words are inserted into the search/query window 2504 and utilized as the basis for the search. In some embodiments, the search/terms query entered into search/query window 2504 represents the information provided to the one or more databases. In other embodiments, additional information may be automatically associated with the search/query terms. For example, in some embodiments additional information may include information related to the participants of the deposition (e.g., speaker, deponent, etc.). In some embodiments, additional information may include the type of search to be conducted. For example, if a single word is provided, then a default keyword search may be conducted. If a string of words is provided, then instead of a keyword search a more sophisticated type of search may be conducted such as a semantic search. In some embodiments, the additional information (e.g., deposition participant, type of search, etc.) is provided automatically to the one or more databases to be search. In other embodiments, the additional information may be presented with the additional information and may modify the additional information provided and/or remove the additional information from being provided. For example, if the user does not want the search to be related to or based on the participants of the deposition, then information identifying the deposition participants may be removed from the information provided to the one or more databases.

Based on the search/query information (as well as any additional information supplied related to the search/query information), one or more databases are searched and results are returned. In some embodiments, search results returned by the one or more databases are displayed in the search results window 2506. The order in which results are displayed may be based on relevance, date, size, type of document, or other. A user opens a document by selecting it within the search results window 2506. In some embodiments, the search results summary window 2508 summarizes the results of the search/query conducted. In some embodiments, search results summary window 2508 organizes search results along one or more attributes. For example, in the embodiment shown in FIG. 25 the search results summary window 2508 organizes search results based on document type (e.g., emails, documents, excel files, powerpoint files, publications, and other). In some embodiments, these categories may be further sub-divided. For example, the category related to emails may be further organized by sender, recipient, attachments present, etc. In other embodiments, search results may be summarized in other way such as by date, file size, etc.

In some embodiments, a user navigates search results by clicking on one or more of the categories presented in the search results summary window 2508, which displays results associated with the category selected. The user may then further navigate the results presented and select individual results (e.g., document, email, etc.) to display and review. In some embodiments, a selected document is opened in a new window, typically utilizing the software associated with the document (e.g., Microsoft Word document opened in Microsoft Word, etc.).

With reference to FIG. 26, an exemplary embodiment is illustrated in which the microphone is located external (top embodiment) and internal (bottom embodiment) to the local system. In particular, in the top embodiments, the microphone 2604 is located external to the local system 2600. Audio recordings captured by the microphone 2604 may be communicated via wired or wireless connection the local system 2600. In some embodiments, the local system 2600 includes a local STT module 2602 for converting the audio recordings to text for display on the local system 2600. In some embodiments, local system 2600 may then communicate via network 2608 with one or more remote system 2610 and/or remote databases 2612 (e.g., e-discover databases). In the bottom embodiments shown in FIG. 26, the microphone 2604′ is included as part of the local system 2600′. Audio recordings captured by the microphone 2604′ may be translated locally by the local system 2600′. In some embodiments, the local system 2600 includes a local STT module 2602′ for converting the audio recordings to text for display on the local system 2600′. In some embodiments, local system 2600′ may then communicate via network 2608′ with one or more remote system 2610′ and/or remote databases 2612′ (e.g., e-discover databases).

With reference to FIGS. 27 and 28, various embodiments are provided wherein speech-to-text (STT) conversion is provided by an STT module located remotely from the local system. In the embodiment shown in FIG. 26, local system 2702 is configured to receive audio recordings captured by microphone 2700. As discussed elsewhere, in some embodiments the audio recordings are divided into a plurality of audio segments communicated to the STT module 2706. In some embodiments the audio segments have a fixed length. In other embodiments, the audio segments may have variable length that correspond with pauses or breaks in talking. The audio recordings may be communicated to the remotely located STT module 2706 via network 2708. A real-time transcript generated by the STT module 2706 may then be communicated to local system 2702 for display to a user. In some embodiments, the real-time transcript generated by the STT module 2706 may also be provided to remote system 2704 for display to authorized users. In some embodiments, one or both of remote system 2704 and local system 2702 may communicate with remote databases 2710 via network 2708. This may include utilizing one or more search terms provided as part of the real-time transcript as inputs to searching remote databases 2710. In some embodiments, remote databases 2710 may include one or more of e-discovery database, scientific literature databases, deposition databases, and/or other types of databases. In the embodiment shown in FIG. 28, the microphone 2800 is included as part of local system 2802 rather than external to it.

Referring now to FIGS. 29 and 30 various embodiments are shown that utilize a real-time transcript made available by a court reporter and/or courter reporter utilizing a real-time transcription system. For example, in the embodiment shown in FIG. 29, a court reporter 2902 utilizing real-time transcription services is utilized to convert speech captured by microphone 2900 to text. In some embodiments, the real-time transcript generated by the court reporter 2902 (utilizing a real-time transcription service) is made available to remote system 2910 and/or local system 2908 via a remote real-time web portal 2906. One or both of the local system 2908 and/or remote system 2910 may then communicate or query remote databases 2916 and/or 2918 via respective networks 2912 and/or 2914. In the embodiment shown in FIG. 30, the court reporter 3002 (utilizing real-time transcription systems) may communicate the real-time transcript via wired or wireless communication to local system 3006. In some embodiments, the court reporter 3002 may communicate the real-time transcript via network 3004 to remote system 3008. In some embodiments, local system 3006 may also communicate with remote system 3008 via network 3012. This may include communication of the real-time transcript itself and/or communication between participants of the deposition and remotely located associates (e.g., associates located remotely from the deposition may message or send communications to a local participants such as an attorney regarding questions to ask).

Referring now to FIGS. 31 and 32, embodiments are shown in which a court reporter is utilized in conjunction with a real time transcription system 3100 to generate real time transcript. In some embodiments, the real time transcription system 3100 utilizes a stenographic machine 3102 to aid in generating the real-time transcription. In some embodiments, the stenographic machine 3102 may operate automatically to convert audio captured by microphone (not shown) to a stenographic transcript (i.e., comprised of stenographic symbols). In this example, the stenographic machine 3102 may include one or more dictionaries of terms utilized to aid in converting audio data to transcribed stenographic symbols. In other embodiments, stenographer machine 3102 may be operated by a court reporter or stenographer that generates the stenographic transcription in real-time. The stenographic transcription (comprised of stenographic symbols) is provided to stenographic transcription computer 3104. In some embodiments, stenographic transcription computer 3104 is located locally. In other embodiments, stenographic transcription computer 3104 may be located remotely, wherein the stenographic transcription is communicated via one or more networks to the stenographic transcription computer 3104.

In some embodiments, stenographic transcription computer 3104 is implemented on a computer that operates/executes CAT software module 3106 and one or more dictionaries 3108. CAT software module 3106 reads the stenographic symbols and utilizes the one or more dictionaries 3108 to convert the stenographic symbols into text to provide a real-time transcript. In some embodiments, the real-time transcript is communicated via wired or wireless communication networks to local systems 3200 and/or 3202. In this way, participants of a deposition may receive a real-time transcript for display. In addition, in some embodiments the real-time transcript is communicated via network 3208 to remote real-time web server 3210. In some embodiments, the remote real-time web server 3210 makes the real-time transcript available via network 3208 to one or more remote systems 3206. In some embodiments, one or both of local system 3200 and/or 3202 may communicated with remote system 3206 via network 3204. For example, this may allow participants to communicate (e.g., via messaging, emails, etc.) and/or exchange documents during the deposition.

Referring to FIG. 33, a flowchart illustrating some embodiments of how the ALPA system may utilize a real-time transcript created during the deposition in conjunction with an e-discovery database to retrieve relevant documents in real-time during the deposition. In some embodiments, the user (e.g., attorney conducting the deposition) at step 3300 establishes a custom dictionary of terms, words, and/or proper names. In some embodiments, the custom dictionary is utilized by the speech-to-text (STT) module to aid in correctly identifying/translating complex terms—including proper names—that may be discussed in the deposition. In some embodiments, the custom dictionary is utilized to coordinate automatic searches of the e-discovery database in response to one or more of the terms, words, and/or proper names being spoken by the deponent (or other participant in the deposition).

At step 3302, the user establishes designated content, the presence of which initiates one or more search processes. For example, the user could enter a particular model of product as designated content, wherein during the deposition if the deponent refers to the particular model of product then an automated search of the e-discovery database is triggered utilizing the designated content. As another example, the user-designated content may include references to individuals. Regardless of the type of designated content, the system may be configured to initiate a process, such as a search as in 3306. In some embodiments, steps 3300 and 3302 are performed prior to the start of the deposition.

In some embodiments, having started the deposition, at step 3304 converted text (i.e., the real-time transcript) is displayed on one or more user interfaces by the ALPA system, including on the user interfaces of individuals utilizing the ALPA to participate remotely (from the witness). As discussed above, real-time transcription may utilize automated tools, transcription experts, and/or a combination of both, and conversion of audio segments to text may occur remotely (using transcriptionists or speech-to-text conversion services or processes) or locally (in any manner). At step 3306, the ALPA system monitors the converted text for matches between the designated content (established at steps 3300 and 3302) and the converted speech. A match detected at step 3310 results in an automatic search process being initiated at step 3312. In some embodiments, the automatic search process includes providing the designated content (and or other content) that appeared in the converted text to an e-discovery database for searching. In some embodiments, in response to a plurality of designated content matches, search strings utilizing a combination of designated content matches may also be generated and utilized as a basis for conducting searches of e-discovery databases. Although in other embodiments, each match with a designated content word, term or proper name results in a stand-alone search. At step 3312 the designated search is conducted and results displayed to the user (either locally, remotely, or a combination of both).

At step 3308, rather than initiate automatic searches in response to designated content matches as described with respect to steps 3306-3312, at step 3308 a user may designate content with the converted speech (e.g., real-time transcript) as the basis for a search. This may include individual words, phrases, sentences, paragraphs, etc.). At step 3314, a search of the one or more e-discovery databases is launched in response to the user-designated content selected by the user. In some embodiments, the type of content selected dictates the type of search conducted (e.g., Boolean, Proximity, Stemming, Fielded, Semantic, conceptual, or Fuzzy logic type searches). In addition to user-designated searches shown at steps 3308 and 3314, in some embodiments at step 3316 the user-designated search may be augmented or edited by a user or by other users of the system (for example, a remotely located associate of the user taking the deposition). The modified user-designated search is then utilized as the input to the one or more e-discovery databases (or third party databases) at step 3318.

FIG. 34 is a flowchart illustrating initialization of the ALPA system according to some embodiments. At step 3406 a user of the ALPA system 3402 (i.e., Armatus) sets up access to a database (referred to herein as a Relativity database 3404). At step 3408 the user may be required to provide a Relativity Host URL, Client ID, and/or Client Secret to provide Armatus 3402 with access to the Relativity Database 3404. At step 3410, a request is sent by the Armatus system 3402 to the Relativity Database 3404. At step 3414, the Relativity Database 3404 (or instance of the Relativity Database) verifies the Client ID and Secret (i.e., password) provided by the Armatus system 3402. In some embodiments, the Relativity Database 3404 provides the Armatus system with a login screen displayed to the user. At step 3416 the user enters username/password information using the login screen displayed by the Relativity Database 3404. At step 3418 the Relativity Database 3404 authenticates and authorizes the use. At step 3420 the a token is generated that grants the Armatus system 3402 with access to the Relativity Database. In some embodiments, the token expires after a set amount of time. At step 3422 the Armatus system 3402 stores the token and a list of workspace and indices for which the token grants access. At step 3426 the user is able to select from the available workspaces and indices those to be included in search queries during the deposition. For example, a user may select all available databases, or a subset of databases to be queried for results.

FIG. 35 is a flowchart illustrating steps taken to initiate a query from the ALPA system 3402 (referred to herein as Armatus) and an e-discovery database 3404 (referred to herein as Relativity Database). At step 3400 a keyword is provided. In some embodiments, the keyword is selected by the user 3400 via highlighting of one or more terms appearing in the real-time transcript. In other embodiments, the user 3400 may provide a search term independent of the real-time transcript. In still other embodiments, the ALPA system 3402 may automatically select one or more search terms from the real-time transcript to initiate a search.

At step 3502, a request is sent to the Relativity Database 3404 using an access token previously granted to the user. At step 3504, the Relativity Database 3404 reviews the token. At step 3506 if the token is valid, then the Relativity Database 3404 conducts a search of one or more databases (previously selected by the user) and returns results to the user at step 3508. In some embodiments, the ALPA system 3402 displays the results for the user to review. At step 3510, if the token is not valid then an error code is generated and at step 3512 the ALPS system 3402 displays a message directing the user to a login screen. At step 3514, the user enters username/password information. At step 3516 the Relativity Database 3404 utilizes the username/password information to authenticate the use and at step 3518 provides a new token.

FIG. 36 is a flowchart illustrating steps taken to provide properly formatted search terms to a database. In some embodiments, at step 3600 a user designates content within a real-time transcript to serve as the basis of a query or search. At step 3602, the designated content (e.g., word, term, sentence, paragraph, etc.) is formatted as required to be compatible with the target database to be searched. In some embodiments, the type of content designated as the basis of the search determines the format of the search query. For example, a single word selected as the search term may result in a simple keyword search. In other embodiments, a single word may result in a simple keyword search with stemming turned On to find words that have the same root or meaning. In some embodiments, if multiple words are selected (e.g., paragraph), then semantic searching may be utilized as the search format.

In some embodiments, at step 3604 the designated content may be augmented/modified with additional input or search operators. In some embodiments, the augmentation/modification of the designated content is done by the user. In other embodiments, the augmentation/modification of the designated content may be performed by a third-party granted access by the user (e.g., remotely located associate of the user). In some embodiments, augmentation/modification of the designated content includes adding additional search terms or search operators to the original query.

At step 3606, the designated content—properly formatted and/or augmented/modified—is provided to the target database. At step 3608, a search of the target database is conducted based on the designated content provided. At step 3610, results from the query are generated. At step 3612, information corresponding to the documents or data retrieved as part of the query from the one or more target databases are arranged utilizing one or more factors and displayed to the user. In some embodiments, results communicated to the user does not include the documents themselves, but rather an identification of the documents relevant to the query, such as file type, document size, authorship, recipients or any other characteristic. In some embodiments, factors utilized to arrange the documents generated as a result of the query may include one or more of relevance, document type, document data. Other factors may be utilized as well. In an embodiment, the system may be configured to permit the user to identify one or more aspects of the case, such as case type (patent infringement, securities, mass tort) and identify one or more characteristics of the witness (e.g., witness type, such as fact witness, expert witness, corporate or 30(b)(6) witness). In an embodiment, an AI module may be employed to predict which of the returned documents are most likely to prove useful to a questioning attorney and a specific witness (documents being useful in questioning a damages expert in a patent infringement matter differing meaningfully from the set of documents that are useful in questioning a technical expert in a product liability case, as determined utilizing an AI module trained through the provision of documents, data and depositions from prior cases). Regardless, in such a manner, the system may be configured to preferentially triage, display or make available documents based on articulated factors, preferences, rules, or AI modules, as examples.

FIG. 37 is a flowchart illustrating analysis of speech segments in real-time to make determinations regarding the state of the person being deposed. In some embodiments, at step 3700 audio data from a deposition or proceeding is captured by a microphone. At step 3702 audio data is gathered and/or processed to eliminate or reduce noise or non-voice data. In some embodiments, audio data obtained during a deposition may be obtained or processed in a manner to eliminate or reduce non-voice data (reduce or eliminate background or ambient noise), including via mechanical means (e.g., dampening) or non-mechanical means (e.g., computer processing). In an embodiment, the audio data may be subject to a normalization process, for example due to the loudness or volume. In an embodiment, the system may adjust the frequency of the voice-based audio input to a desired level (e.g., to 8 kHz). In an embodiment, the audio input may be converted to an alternative file type, such as a mono-audio file.

At step 3704, audio data is converted to a desired format—if not already in the desired format. At step 3706, one or more audio data parameters (such as speech characteristics) are quantified, measured, and/or analyzed. In some embodiments, speech data, however obtained, prepared and/or optimized may be analyzed, quantified or measured based on a variety of methods known in the art (in real-time or after the fact). In addition to other factors, audio data may be analyzed with respect to vocal characteristics, articulation, speech pace, pitch, pitch variation, energy, troughs and peaks, and effort, among others.

At step 3710, one or more thresholds are established indicative of the presence or absence of a speaker's mental state. In some embodiments these thresholds are pre-determined or well-understood. In other embodiments, the thresholds may be dynamically set in response to audio data parameters quantified during an initial or preliminary period with the deponent. At step 3708, one or more speech parameters quantified at step 3706 are compared to the one or more thresholds. In some embodiments, quantified or measured audio data parameters are compared, using any methodology in the art, to established thresholds relating to the presence or absence of a mental state in a witness. In an embodiment, the measured audio data parameters are compared to one or more data models containing data indicative of one or more mental states. In an embodiment, the system initiates a process to calculate, from the derived measurements, one or more values wherein the audio data values from a witness during a deposition are compared to the values. In an embodiment, probability values associated with the presence or absence of a mental state in a deposition witness are calculated. In an embodiment, where the calculated result is withing designated parameters, an indicator may be displayed on a user interface. In another embodiment, the presence or absence of a mental state, or data related thereto, may be utilized to indicate, in conjunction with a transcript generated from witness speech, parts of that transcribed speech that correspond with the presence or absence of a mental state of the speaker. At step 3712, determinations are made regarding the mental state of the deponent (or other participants) based on the comparison of the one or more speech parameters to the one or more thresholds.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method comprising:
receiving an output signal from one or more microphones, the output signal representing content from a proceeding having two or more participants;
generating a real-time transcript based on the received output signal;
displaying the real-time transcript via a user interface;
selecting search terms from the real-time transcript;
conducting a search of a database storing electronic documents related to the proceeding based on the selected search terms; and
displaying the search results via the user interface.

2. The method of claim 1, wherein selecting search terms based on the real-time transcript includes receiving input via the user interface selecting one or more words within the real-time transcript.

3. The method of claim 2, further including generating search parameters based on the selected search terms, wherein generating search parameters includes selecting a type of search to perform based on the selection of one or more words.

4. The method of claim 2, wherein the type of search performed is selected from a group including one or more of Boolean, Proximity, Stemming, Fielded, Semantic, conceptual, or Fuzzy logic type searches.

5. The method of claim 1, further including:
receiving input from a user identifying a first subset of documents that are relevant to the proceeding;
analyzing the first subset of documents to identify a first set of keywords;
storing the first set of keywords; and
comparing the real-time transcript to the first set of key words, wherein the search terms are selected based on the comparison of the first subset of keywords to the real-time transcript.

6. The method of claim 1, further including:
initializing a speech-to-text (STT) module utilized to convert the output signal to the real-time transcript prior to a start of the proceedings, wherein initializing the STT module includes performing a search of the electronic documents stored in the database to identify infrequently used terms relevant to the proceedings, wherein the identified infrequently used terms are utilized to augment the STT module.

7. The method of claim 6, wherein the search of the electronic document stored in the database to identify infrequently used terms includes identifying terms that are not stored in a library associated with the STT module.

8. The method of claim 6, wherein generating the real-time transcript includes providing links to one or more electronic documents stored in the database associated with identified infrequently used terms.

9. The method of claim 1, further including:
initializing a name recognition module prior to a start of the proceedings, wherein initializing the name recognition module includes performing a search of the electronic documents stored in the database to identify names associated with a proceeding, wherein the identified names are compared with the real-time transcript to generate alerts in response to a detected ambiguity in a name appearing in the real-time transcript.

10. The method of claim 9, wherein the alert is displayed to a user via the user interface and provides a list of possible names corresponding with the detected ambiguity.

11. The method of claim 1, further including:
initializing the database to identify a first subset of relevant electronic documents based on input provided regarding a type of proceeding; and
applying training data selected based on the type of proceeding to identify the first subset of relevant electronic documents, wherein conducting a search of the database storing electronic documents related to the proceeding based on the selected search terms includes searching the first subset of relevant documents.

12. A system comprising:
at least one microphone;
a user interface device accessible to at least one of a plurality of deposition participants; and
an audio translation engine, comprising:
an audio storage module configured to store at least one representation of audio recorded by the at least one microphone during a deposition proceeding;
a speech-to-text module configured to convert speech of the recorded audio into a textual representation of the speech; and
a transcript generator module configured to generate a document representing a transcript of the deposition based on the converted speech and the identified which of the plurality of deposition participants spoke the one or more portions;
a search engine configured to interface with a database storing electronic documents relevant to the deposition proceeding, the search engine configured to generate search parameters based on the generated transcript and to display results via the user interface.

13. The system of claim 12, wherein the user interface displays the transcript of the deposition and allows a user to highlight text from the transcript to be provided as an input to the search engine.

14. The system of claim 12, wherein the search engine generates a list of key words based on a first subset of documents identified as relevant, wherein the search engine generates the search parameters based on he comparison of the list of key words to the transcript.

15. The system of claim 12, wherein the speech-to-text module is initialized by performing an analysis of electronic documents stored in the database to identify infrequently used or scientific terms, wherein the speech-to-text module is augmented to include the identified infrequently used terms.

16. The system of claim 15, wherein the audio translation engine further includes a name recognition module, wherein the name recognition module is initialized by performing an analysis of electronic documents stored in the database to identify names relevant to the deposition proceedings, wherein the name recognition module is updated with the identified names.

17. The system of claim 16, wherein the name recognition module identifies references to names in the transcript that are ambiguous with respect to the identified names, wherein the name recognition module generates an alert in response to a detected ambiguity.

18. The system of claim 12, wherein the speech-to-text module and the transcript generator module generate the document representing the transcript in real-time.

19. A computer readable storage medium having data stored therein representing software executable by a computer, the software including instructions that when executed by the computer perform the following steps:
receiving an electronic version of a real-time transcript generated in response to an on-going proceeding;
displaying the real-time transcript via a display;
selecting content from the real-time transcript based on input received from one or more users granted access to the real-time transcript;
formatting a search query based on the selected content;
communicating the search query to a database;
receiving information identifying one or more documents retrieved in response to the search query; and
displaying information identifying the one or more documents retrieved in response to the search query.

20. The computer readable storage medium of claim 19, wherein formatting the search query includes selecting from one of Boolean, Proximity, Stemming, Fielded, Semantic, Conceptual, or Fuzzy logic type search queries based on attributes of the selected content, including whether the selected content is a word, phrase, sentence, paragraph or an entire document.

21. The computer readable storage medium of claim 19, further including the following steps:
receiving input from a user identifying a first subset of documents that are relevant to the proceeding;
analyzing the first subset of documents to identify a first set of keywords;
storing the first set of keywords; and
comparing the real-time transcript to the first set of key words, wherein selecting content from the real-time transcript includes selecting content matching one or more of the first set of keywords.

22. The computer readable storage medium of claim 19, wherein selecting content from the real-time transcript based on input received from one or more users granted access to the real-time transcript further includes receiving input from a user augmenting or modifying the selected content prior to communicating the search query to the database.
